(19) United States
(12) Patent Application Publication
(10) Pub. No.: US 2023/0305288 A1
(43) Pub. Date: Sep. 28, 2023

(54) VARIABLE WAVELENGTH INTERFERENCE FILTER

(71) Applicant: SEIKO EPSON CORPORATION, TOKYO (JP)

(72) Inventor: Akira SANO, Matsumoto-shi (JP)

(21) Appl. No.: 18/189,301

(22) Filed: Mar. 24, 2023

(30) Foreign Application Priority Data
Mar. 28, 2022 (JP) 2022-052233

(51) Int. Cl. G02B 26/00

(52) U.S. Cl. CPC G02B 26/001

(57) ABSTRACT

A variable wavelength interference filter includes a first substrate, a second substrate facing the first substrate via a predetermined gap, a first reflection film installed at the first substrate, a second reflection film installed at the second substrate, and facing the first reflection film via a first gap, a coupling portion disposed between the first substrate and the second substrate, and a driving unit configured to change the first gap. The coupling portion has a part of a first facing surface coupled to the first substrate. The first facing surface faces the first substrate. A portion of the first facing surface of the coupling portion not coupled to the first substrate constitutes a displacement portion facing the first substrate via a second gap. A part of a second facing surface of the displacement portion is coupled to the second substrate. The second facing surface faces the second substrate. The driving unit changes the second gap by bending the displacement portion, thereby changing the first gap.

The present application is based on, and claims priority from JP Application Serial Number 2022-052233, filed Mar. 28, 2022, the disclosure of which is hereby incorporated by reference herein in its entirety.

### BACKGROUND

### 1. Technical Field

The present disclosure relates to a variable wavelength interference filter.

### 2. Related Art

In the related art, a variable wavelength interference filter including a pair of mirrors disposed so as to face each other and capable of changing a dimension between the mirrors has been known (for example, see JP-A-2002-277758).

The variable wavelength interference filter described in JP-A-2002-277758 holds, at a holder, each of a pair of optical substrates provided with a reflection layer, and couples the pair of optical substrates by a piezoelectric element of the holders. The pair of reflection layers are disposed so as to face each other via a gap, and a voltage is applied to the piezoelectric element to change a gap dimension between the pair of reflection layers. In this way, a wavelength of light transmitted through the pair of reflection layers can be changed while suppressing a bend of each of the optical substrates.

However, a change amount of the gap dimension is limited in the configuration as in JP-A-2002-277758 in which the piezoelectric element is disposed between the holders, and a voltage is applied to the piezoelectric element to change the gap dimension between the reflection layers. In contrast, in order to increase a change amount of the gap dimension, it is also conceivable to increase a thickness dimension of the piezoelectric element. However, it is difficult to form the piezoelectric element having a great thickness with high accuracy, and distortion or an inclination occurs in a substrate when a piezoelectric element having poor dimensional accuracy is used. When distortion or an inclination occurs in the substrate in such a manner, a degree of parallelism between a pair of mirrors decreases, a wavelength of light transmitted through a variable wavelength interference filter varies within a plane, light other than light having a target wavelength is also transmitted through the variable wavelength interference filter, and the light having the target wavelength cannot be accurately transmitted.

### SUMMARY

A variable wavelength interference filter according to one aspect of the present disclosure includes a first substrate, a second substrate facing the first substrate via a predetermined gap, a first reflection film installed at the first substrate, a second reflection film installed at the second substrate, and facing the first reflection film via a predetermined first gap, a coupling portion disposed between the first substrate and the second substrate, and including a first facing surface facing the first substrate and a second facing surface facing the second substrate, and a driving unit configured to change the first gap, where a part of the first facing surface of the coupling portion is coupled to the first substrate, when viewed from a thickness direction from the first substrate toward the second substrate, a portion of the first facing surface of the coupling portion not coupled to the first substrate constitutes a displacement portion facing the first substrate via a predetermined second gap, a part of the second facing surface of the displacement portion is coupled to the second substrate, and the driving unit changes the second gap by bending the displacement portion, thereby changing the first gap.

### BRIEF DESCRIPTION OF THE DRAWINGS

FIG. 1 is a plan view illustrating a schematic configuration of a variable wavelength interference filter in a first embodiment.

FIG. 2 is a cross-sectional view of the variable wavelength interference filter taken along an A-A line in FIG. 1.

FIG. 3 is a plan view illustrating a schematic configuration of the variable wavelength interference filter excluding a second substrate in the first embodiment.

FIG. 4 is a plan view illustrating a schematic configuration of a first substrate in the first embodiment.

FIG. 5 is a plan view illustrating a schematic configuration of a second substrate in the first embodiment.

FIG. 6 is an enlarged cross-sectional view of a vicinity of a coupling portion in the first embodiment.

FIG. 7 is an enlarged cross-sectional view of the vicinity of the coupling portion when the coupling portion is bent by a driving unit.

FIG. 8 is a flowchart in a method for manufacturing the variable wavelength interference filter in the present embodiment.

FIG. 9 is a diagram schematically illustrating a first substrate formation step.

FIG. 10 is a diagram schematically illustrating a second substrate formation step.

FIG. 11 is a diagram schematically illustrating a coupling portion formation step.

FIG. 12 is a diagram schematically illustrating a bonding step.

FIG. 13 is a cross-sectional view illustrating a schematic configuration of a variable wavelength interference filter according to a second embodiment.

FIG. 14 is a plan view illustrating a schematic configuration of a variable wavelength interference filter according to a third embodiment.

FIG. 15 is a cross-sectional view of the variable wavelength interference filter in FIG. 14 taken along an A-A line.

FIG. 16 is a schematic cross-sectional view illustrating a vicinity of a coupling portion of a variable wavelength interference filter in a fourth embodiment.

FIG. 17 is a schematic cross-sectional view illustrating a vicinity of a coupling portion of a variable wavelength interference filter in a fifth embodiment.

FIG. 18 is a plan view illustrating a schematic configuration of a variable wavelength interference filter in a sixth embodiment.

FIG. 19 is an enlarged cross-sectional view illustrating a vicinity of a coupling portion of the variable wavelength interference filter according to the sixth embodiment.

FIG. 20 is a plan view illustrating a schematic configuration of a variable wavelength interference filter according to a seventh embodiment.

FIG. 21 is a diagram illustrating a schematic configuration of a spectral camera in an eighth embodiment.

FIG. 22 is a schematic cross-sectional view illustrating a vicinity of a coupling portion of a variable wavelength interference filter according to a first modification example.

### DESCRIPTION OF EXEMPLARY EMBODIMENTS

### First Embodiment

A variable wavelength interference filter according to a first embodiment will be described below.

1. Overall Configuration of Variable Wavelength Interference Filter

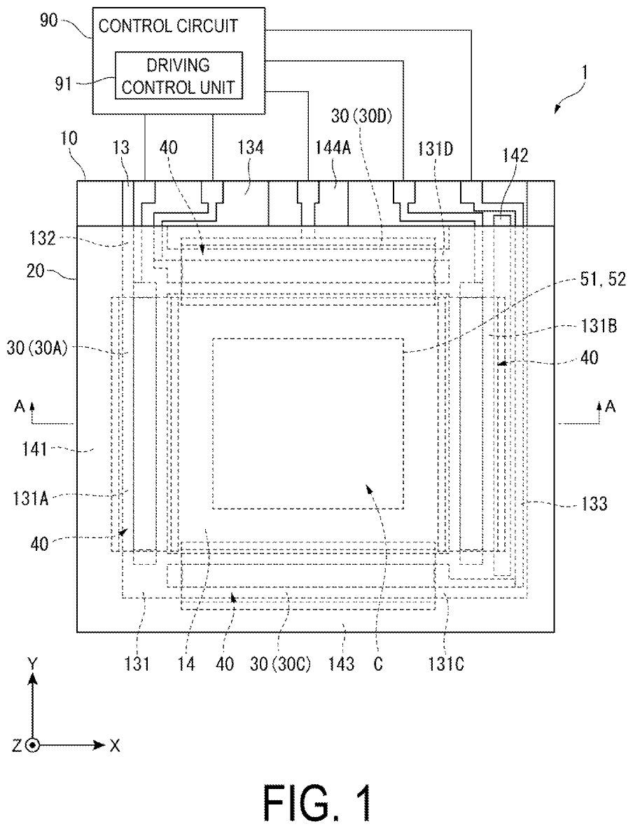

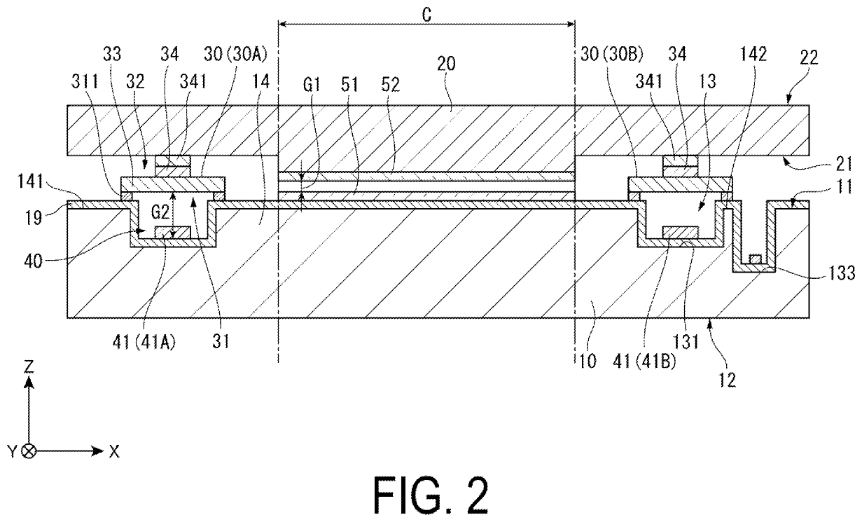

FIG. 1 is a plan view illustrating a schematic configuration of a variable wavelength interference filter 1 according to the first embodiment. FIG. 2 is a cross-sectional view of the variable wavelength interference filter 1 taken along an A-A line.

As illustrated in FIGS. 1 and 2, the variable wavelength interference filter 1 includes a first substrate 10, a second substrate 20, a coupling portion 30, and a driving unit 40.

The first substrate 10 and the second substrate 20 are disposed in parallel so as to face each other. The coupling portion 30 is disposed between the first substrate 10 and the second substrate 20, and couples the first substrate 10 and the second substrate 20. The driving unit 40 is provided between the first substrate 10 and the coupling portion 30, and causes the coupling portion 30 to advance and retreat toward the second substrate 20 and the first substrate 10 by deforming the coupling portion 30.

Each configuration of such a variable wavelength interference filter 1 will be described below in detail.

Further, the following description will be given on an assumption that a direction from the first substrate 10 toward the second substrate 20 is a Z direction, one direction orthogonal to the Z direction is an X direction, and a direction orthogonal to the Z direction and the X direction is a Y direction. The Z direction corresponds to a thickness direction of the present disclosure.

2. Configuration of First Substrate

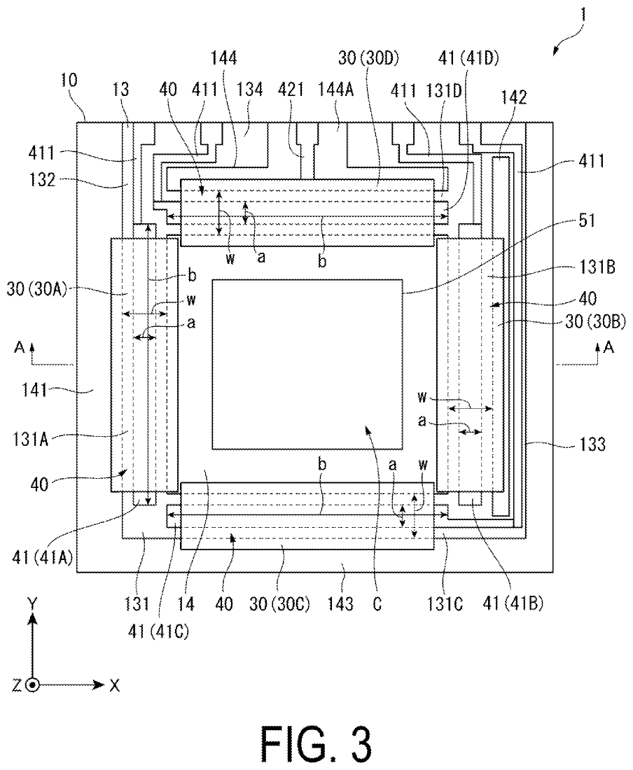

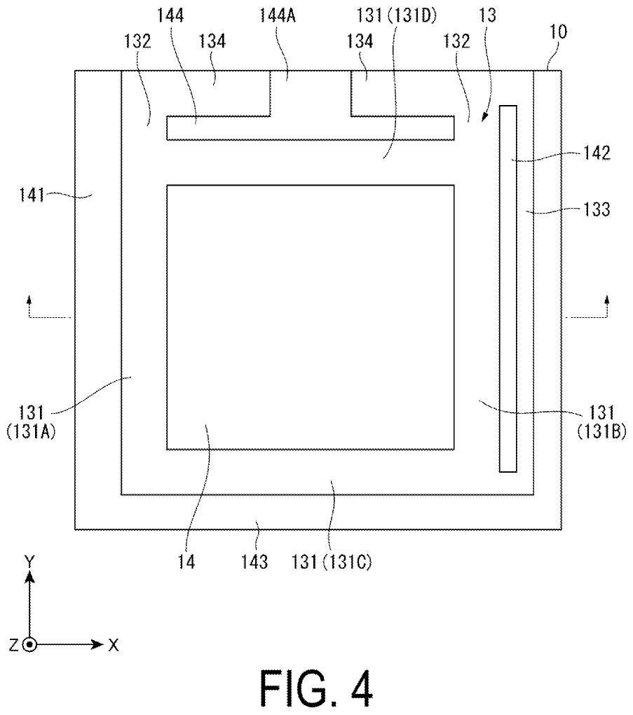

FIG. 3 is a plan view of the variable wavelength interference filter 1 when the second substrate 20 is removed from FIG. 1. FIG. 4 is a plan view of the first substrate 10 when viewed from the +Z side toward the −Z side.

A substrate material according to a wavelength region of light transmitted through the variable wavelength interference filter can be used as the first substrate 10. For example, in the present embodiment, the variable wavelength interference filter 1 transmits light having a predetermined wavelength, including light from a near-infrared region to an infrared region. In this case, the first substrate 10 can be formed of a material that can transmit light from the near-infrared region to the infrared region. For example, in the present embodiment, the first substrate 10 is formed of an Si substrate. Note that, when the variable wavelength interference filter 1 transmits light in a visible light region, the first substrate 10 may be formed of a material such as glass. An external shape of the first substrate 10 in plan view is not particularly limited, but, when the first substrate 10 in a chip unit is cut out from a substrate as a material by laser cutting or the like, the first substrate 10 may be formed in a rectangular shape in terms of a manufacturing step.

Further, a thickness of the first substrate 10 is also not particularly limited, and the first substrate 10 may have a thickness to a degree that a bend does not occur by film stress of a first reflection film 51 or the like formed at the first substrate 10.

Herein, a surface of the first substrate 10 facing the second substrate is referred to as a first substrate surface 11, and a surface on an opposite side to the first substrate surface 11 is referred to as a first rear surface 12. The first substrate surface 11 and the first rear surface 12 are parallel to each other, and a distance from the first substrate surface 11 to the first rear surface 12 is uniform in a portion of the first substrate 10 at which a recessed groove 13 described below is not formed. In other words, the first substrate 10 is formed so as to have a uniform thickness.

As illustrated in FIGS. 2 to 4, the first substrate 10 is provided with the recessed groove 13 formed by, for example, etching or the like at the first substrate surface 11. The recessed groove 13 includes a first groove portion 131 provided at a central portion of the first substrate 10, a second groove portion 132 extending from the first groove portion 131 to the +Y side, a third groove portion 133 disposed on the +X side of the first groove portion 131, and an electrical equipment portion 134.

The first groove portion 131 is formed in a rectangular frame shape surrounding the central portion of the first substrate 10. A region surrounded by the first groove portion 131 in the first substrate surface 11 constitutes a first reflection film region 14 provided with the first reflection film 51. In other words, the first groove portion 131 includes a −X-side first groove portion 131A disposed on the −X side of the first reflection film region 14 to be long in the Y direction, a +X-side first groove portion 131B disposed on the +X side of the first reflection film region 14 to be long in the Y direction, a −Y-side first groove portion 131C disposed on the −Y side of the first reflection film region 14 to be long in the X direction, and a +Y-side first groove portion 131D disposed on the +Y side of the first reflection film region 14 to be long in the X direction.

Further, the first groove portion 131 is configured to have a uniform groove width.

In other words, the −X-side first groove portion 131A is provided between the first reflection film region 14, and a first bridge portion 141 provided along a −X-side end edge of the first substrate 10. A −X-side end edge of the first reflection film region 14 along the −X-side first groove portion 131A, and a +X-side end edge of the first bridge portion 141 are straight lines parallel to the Y direction, and a groove width of the −X-side first groove portion 131A is W.

The +X-side first groove portion 131B is provided between the first reflection film region 14 and a second bridge portion 142 described below. A +X-side end edge of the first reflection film region 14 along the +X-side first groove portion 131B, and a −X-side end edge of the second bridge portion 142 are straight lines parallel to the Y direction, and a groove width of the +X-side first groove portion 131B is W.

The −Y-side first groove portion 131C is provided between the first reflection film region 14, and a third bridge portion 143 provided along a −Y-side end edge of the first substrate 10. A −Y-side end edge of the first reflection film region 14 along the −Y-side first groove portion 131C, and a +Y-side end edge of the third bridge portion 143 are straight lines parallel to the Y direction, and a groove width of the −Y-side first groove portion 131C is W.

The +Y-side first groove portion 131D is provided between the first reflection film region 14 and a fourth bridge portion 144 described below. A +Y-side end edge of the first reflection film region 14 along the +Y-side first groove portion 131D, and a −Y-side end edge of the fourth bridge portion 144 are straight lines parallel to the Y direction, and a groove width of the +Y-side first groove portion 131D is W.

Further, a groove bottom surface of the first groove portion 131 is a surface parallel to an XY flat surface, that is, a surface parallel to the first substrate surface 11, and a first driving electrode 41 constituting the driving unit 40 is installed via an insulating layer 19. Details of the first driving electrode 41 will be described below.

The second groove portion 132 is a portion that extends from a ±X-side end portion of the first groove portion 131 to the +Y side, and is coupled to the electrical equipment portion 134 provided along a +Y-side end edge of the first substrate 10. A first extraction electrode 411 coupled to the first driving electrode 41 installed at the groove bottom surface of the first groove portion 131 is disposed at the second groove portion 132.

The second groove portion 132 and the electrical equipment portion 134 are provided, and thus the fourth bridge portion 144 is formed on the +Y side of the first reflection film region 14 with the first groove portion 131 sandwiched therebetween. The first substrate surface 11 of the fourth bridge portion 144 is flush with the first substrate surface 11 of the first reflection film region 14, the first bridge portion 141, the second bridge portion 142, and the third bridge portion 143. A part of the fourth bridge portion 144 is extended to the +Y-side end edge of the first substrate 10, and an extending portion 144A being the part is a portion at which a second extraction electrode 421 of the coupling portion 30 having conductivity described below is installed.

Note that, as illustrated in FIG. 4, the present embodiment illustrates an example in which the second groove portion 132 is provided on each of the ±X sides of the first groove portion 131, and the electrical equipment portion 134 is disposed so as to have line symmetry with respect to an axis line passing through the center of the substrate and being parallel to the Y direction, which is not limited thereto. For example, a length of the electrical equipment portion 134 on the +X side along the X direction, and a length of the electrical equipment portion 134 on the −X side along the X direction may be different from each other. The extending portion 144A of the fourth bridge portion 144 is formed between the electrical equipment portion 134 on the −X side and the electrical equipment portion 134 on the +X side. Thus, when the lengths of the electrical equipment portions 134 are different from each other as described above, a position of the extending portion 144A also changes accordingly.

The third groove portion 133 is a groove that extends from a −Y-side end portion of the first groove portion 131 to the +X side, and further extends to the electrical equipment portion 134 toward the +Y side.

Similarly to the second groove portion 132, the third groove portion 133 is a groove portion at which the first extraction electrode 411 is installed. In other words, in the present embodiment, the first driving electrodes 41 independent of one another are disposed at four sides of the first groove portion 131 having the rectangular frame shape. The first extraction electrodes 411 of the first driving electrodes 41 disposed on the −X side, the +X side, and the +Y side of the first driving electrodes 41 independent of one another are extracted to the electrical equipment portion 134 along the second groove portion 132. The first extraction electrode 411 coupled to the first driving electrode 41 disposed on the −Y side is extracted to the electrical equipment portion 134 through the third groove portion 133.

Note that details will be described below, and, in the present embodiment, the second substrate 20 is formed of an Si substrate similarly to the first substrate 10. In this case, electrostatic attraction may act between the first extraction electrode 411 disposed at the third groove portion 133, and the second substrate 20. Thus, in the present embodiment, the third groove portion 133 is formed so as to have a groove depth deeper than that of the first groove portion 131 and the second groove portion 132.

Then, the third groove portion 133 is provided, and thus the second bridge portion 142 being long along the Y direction is formed between the first groove portion 131 and the third groove portion 133. The first substrate surface 11 of the second bridge portion 142 is flush with the first substrate surface 11 of the first reflection film region 14.

Note that the present embodiment illustrates an example in which the third groove portion 133 is provided on the +X side of the first groove portion 131, which is not limited thereto. For example, the third groove portion 133 may be a groove that extends from the −Y-side end portion of the first groove portion 131 to the −X side, and further extends to the electrical equipment portion 134 toward the +Y side, that is, a groove disposed on the −X side of the first groove portion 131.

As described above, the electrical equipment portion 134 is a portion from which the first extraction electrode 411 coupled to each of the first driving electrodes 41 is extracted.

Further, as described above, a +Y-side end portion of the first substrate 10 protrudes further than a +Y-side end portion of the second substrate 20, and the electrical equipment portion 134 is disposed at the protruding portion. Thus, each of the first extraction electrodes 411 extracted to the electrical equipment portion 134 is exposed from the +Z side, and, for example, a lead wire, flexible printed circuits (FPC), and the like can be coupled to each of the first extraction electrodes 411.

Note that the present embodiment exemplifies a configuration in which the first extraction electrode 411 is provided at a front surface of the electrical equipment portion 134, the second extraction electrode 421 is provided at the extending portion 144A of the fourth bridge portion 144, and a lead wire and an FPC are coupled to the extraction electrodes 411 and 421 from the +Z side, which is not limited thereto. For example, a through electrode penetrating the first substrate 10 may be provided in a formation position of the first extraction electrode 411 of the electrical equipment portion 134 or a formation position of the second extraction electrode 421 of the extending portion 144A, and an electrode pad conducted to the through electrode may be provided on the first rear surface 12 side of the first substrate 10. In this case, a lead wire and an FPC may be coupled to the first rear surface 12 side of the first substrate 10.

The insulating layer 19 having a uniform thickness is provided at the first substrate surface 11 of the first substrate 10. Then, the first reflection film 51 and the first driving electrode 41 are provided at the first substrate surface 11 of the first substrate 10 via the insulating layer 19, and the first extraction electrode 411 is provided at the first substrate surface 11. Note that, since an Si substrate is used as the first substrate 10 in the present embodiment, the insulating layer 19 is formed, but, when the first substrate 10 is formed of, for example, an insulator such as glass, formation of the insulating layer is unnecessary.

As described above, the first reflection film 51 is installed at the first reflection film region 14 via the insulating layer 19. As the first reflection film 51, for example, a metal film of Ag or the like, an alloy film of an Ag alloy or the like, a dielectric multilayer film in which a high refractive layer (for example, TiO₂) and a low refractive layer (for example, SiO₂) are stacked, or the like can be used.

Further, the present embodiment illustrates an example in which the first reflection film 51 is formed in a rectangular shape in plan view, but the shape of the first reflection film 51 is not particularly limited, and may be a circle, an ellipse, another polygonal shape, or the like.

The first driving electrode 41 is installed at the groove bottom surface of the first groove portion 131 of the recessed groove 13 via the insulating layer 19. In the present embodiment, as illustrated in FIG. 3, a plurality of the first driving electrodes 41 are provided around the first reflection film 51. Specifically, the plurality of first driving electrodes 41 are disposed so as to have rotational symmetry with respect to a central point of the first reflection film 51. For example, in the present embodiment, the first driving electrode 41 being long in a side direction is provided for each of the sides of the first groove portion 131 having the rectangular frame shape surrounding the first reflection film region 14. The first driving electrodes 41 are formed in the same shape.

Further, each of the first driving electrodes 41 is disposed at a central portion of the groove bottom surface of the first groove portion 131. For example, a −X-side first driving electrode 41A installed at the −X-side first groove portion 131A is formed in a rectangular shape having a length b in the Y direction and a width a in the X direction, and are installed such that the center of the width of the −X-side first groove portion 131A in the X direction and the center of the width of the −X-side first driving electrode 41A in the X direction coincide with each other.

Similarly, a +X-side first driving electrode 41B installed at the +X-side first groove portion 131B is formed in a rectangular shape having a length b in the Y direction and a width a in the X direction, and are installed such that the center of the width of the +X-side first groove portion 131B in the X direction and the center of the width of the +X-side first driving electrode 41B in the X direction coincide with each other.

A −Y-side first driving electrode 41C installed at the −Y-side first groove portion 131C is formed in a rectangular shape having a length b in the X direction and a width a in the Y direction, and are installed such that the center of the width of the −Y-side first groove portion 131C in the Y direction and the center of the width of the −Y-side first driving electrode 41C in the Y direction coincide with each other.

A +Y-side first driving electrode 41D installed at the +Y-side first groove portion 131D is formed in a rectangular shape having a length b in the X direction and a width a in the Y direction, and are installed such that the center of the width of the +Y-side first groove portion 131D in the Y direction and the center of the width of the +Y-side first driving electrode 41D in the Y direction coincide with each other.

As described above, the first extraction electrode 411 is coupled to each of the first driving electrodes 41, and is individually extracted to the electrical equipment portion 134. In other words, the first extraction electrodes 411 coupled to the −X-side first groove portion 131A, the +X-side first groove portion 131B, and the +Y-side first groove portion 131D are extended to the electrical equipment portion 134 through the second groove portion 132. Further, the first extraction electrode 411 coupled to the −Y-side first groove portion 131C is extended to the electrical equipment portion 134 through the third groove portion 133. Each of the first extraction electrodes 411 may be formed so as to be wide at a tip portion in a vicinity of an outer peripheral edge of the first substrate 10, and may constitute an electrode pad.

Then, in the present embodiment, a plurality of the coupling portions 30 are provided so as to cover a part of the first groove portion 131. In other words, the coupling portion 30 is bonded to the first substrate 10 by a first bonding layer 311 in a position in which the first groove portion 131 is sandwiched.

3. Configuration of Second Substrate

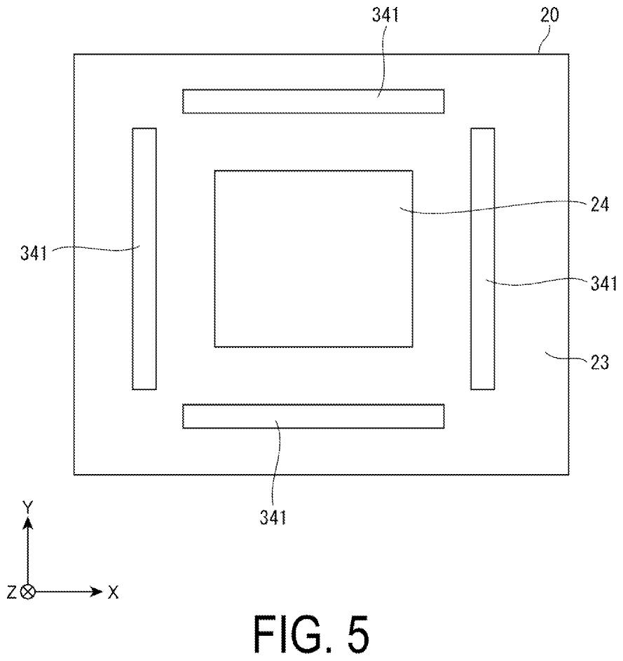

FIG. 5 is a plan view of the second substrate 20 viewed from the −Z side (first substrate 10 side).

A substrate material according to a wavelength region of light transmitted through the variable wavelength interference filter 1 can be used as the second substrate 20. For example, in the present embodiment, the second substrate 20 may be formed of a material that can transmit light from the near-infrared region to the infrared region. Note that, since the coupling portions 30 are conducted to each other via the second substrate 20 in the present embodiment, the second substrate 20 may be formed of an Si substrate having conductivity.

Note that an Si substrate is used as the second substrate 20 in the present embodiment, but, for example, when the second substrate 20 is formed of an insulator such as glass, conduction to each of the coupling portions 30 can be achieved by forming a conductive transparent film of ITO or the like at a surface of the second substrate 20 facing the first substrate 10.

An external shape of the second substrate 20 in plan view is not particularly limited, but the second substrate 20 may be formed in a rectangular shape similarly to the first substrate 10. Further, a thickness of the second substrate 20 is also not particularly limited, and the second substrate 20 may have a thickness to a degree that a bend does not occur by film stress of a second reflection film 52 or the like formed at the second substrate 20.

Herein, a surface of the second substrate 20 facing the first substrate 10 is referred to as a second substrate surface 21, and a surface on an opposite side to the second substrate surface 21 is referred to as a second rear surface 22. The second substrate surface 21 and the second rear surface 22 are surfaces parallel to each other.

For example, the second substrate surface 21 of the second substrate 20 has a step formed so as to protrude to the first substrate 10 side at a central portion of the second substrate 20 by surface treatment such as etching. The central portion of the second substrate 20 is a second reflection film region 24 provided with the second reflection film 52, and includes the flat second substrate surface 21.

In the second substrate 20, a region surrounding the second reflection film region 24 is a coupling region 23 to which the coupling portion 30 is coupled, and is provided in a position away from the first substrate 10 farther than the second substrate surface 21 of the second reflection film region 24.

Herein, in the present embodiment, the second substrate 20 moves toward the first substrate 10 by deformation of the coupling portion 30, and thus a dimension of a gap (first gap G1) between the first reflection film 51 and the second reflection film 52 changes. A change range of the first gap G1 is appropriately set according to a wavelength range of light transmitted through the variable wavelength interference filter 1, and changes in a range of 1 μm or less. Meanwhile, the coupling region 23 is a portion at which the first substrate 10 and the second substrate 20 are bonded to each other via the coupling portion 30. Therefore, when the second substrate surface 21 of the second reflection film region 24 and the second substrate surface 21 of the coupling region 23 are flush with each other, the first gap G1 is too great, and thus it is difficult to accurately transmit light of a desired wavelength. Thus, in the present embodiment, the step is provided between the coupling region 23 and the second reflection film region 24 by etching or the like, and the second reflection film region 24 is formed so as to protrude to the first substrate 10 side.

As the second reflection film 52 provided at the second reflection film region 24, a reflection film having the same configuration as that of the first reflection film 51 described above can be used, and, for example, a metal film of Ag or the like, an alloy film of an Ag alloy or the like, a dielectric multilayer film in which a high refractive layer (for example, TiO₂) and a low refractive layer (for example, SiO₂) are stacked, or the like can be used.

Further, in the present embodiment, the second reflection film 52 is formed in the same shape as that of the first reflection film 51 in plan view, and the first reflection film 51 and the second reflection film 52 overlap each other when viewed along the Z direction. A region where the first reflection film 51 and the second reflection film 52 overlap each other serves as an optical region C. Light incident on the optical region C is subjected to multiple reflection between the first reflection film 51 and the second reflection film 52, and light having a predetermined wavelength according to the dimension of the first gap G1 is reinforced by interference and transmitted through the variable wavelength interference filter 1.

4. Configuration of Coupling Portion

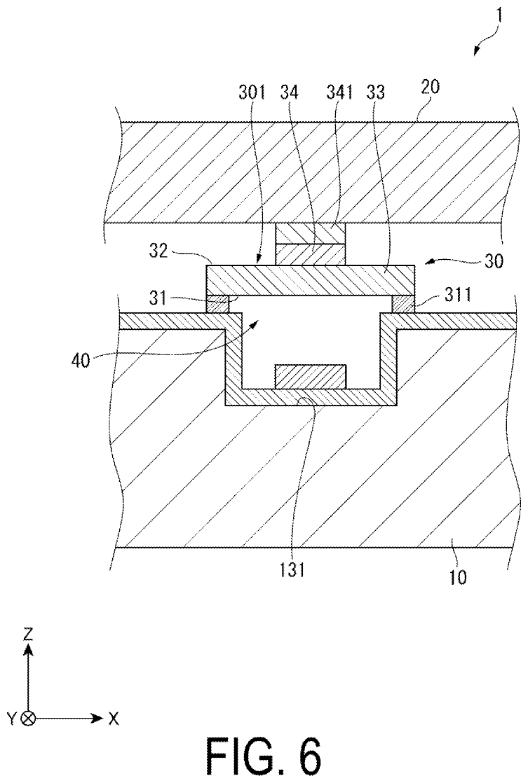

FIG. 6 is an enlarged cross-sectional view of a vicinity of the coupling portion 30 in FIG. 2.

As described above, the coupling portion 30 is provided so as to cover the first groove portion 131 of the first substrate 10, and couples the first substrate 10 and the second substrate 20. Herein, a surface of the coupling portion 30 facing the first substrate 10 is referred to as a first facing surface 31, and a surface of the coupling portion 30 facing the second substrate 20 is referred to as a second facing surface 32.

In the present embodiment, as illustrated in FIGS. 3 and 6, the coupling portion 30 is formed in a rectangular shape in plan view, and four coupling portions 30 are provided for the four sides of the first groove portion 131.

In other words, a first coupling portion 30A that bridges the first reflection film region 14 and the first bridge portion 141 to cover the −X-side first groove portion 131A, a second coupling portion 30B that bridges the first reflection film region 14 and the second bridge portion 142 to cover the +X-side first groove portion 131B, a third coupling portion 30C that bridges the first reflection film region 14 and the third bridge portion 143 to cover the −Y-side first groove portion 131C, and a fourth coupling portion 30D that bridges the first reflection film region 14 and the fourth bridge portion 144 to cover the +Y-side first groove portion 131D.

The first coupling portion 30A has a rectangular shape being long in the Y direction, and ±X-side end portions of the first facing surface 31 are bonded to the −X-side end edge of the first reflection film region 14 and the +X-side end edge of the first bridge portion 141 by the first bonding layer 311 formed of an Au film or the like. A portion of the first coupling portion 30A facing a groove bottom surface of the −X-side first groove portion 131A constitutes a displacement portion 301 of the first coupling portion 30A.

The second coupling portion 30B has a rectangular shape being long in the Y direction, and ±X-side end portions of the first facing surface 31 are bonded to the +X-side end edge of the first reflection film region 14 and the −X-side end edge of the second bridge portion 142 by the first bonding layer 311. A portion of the second coupling portion 30B facing a groove bottom surface of the +X-side first groove portion 131B constitutes the displacement portion 301 of the second coupling portion 30B.

The third coupling portion 30C has a rectangular shape being long in the X direction, and ±Y-side end portions of the first facing surface 31 are bonded to the −Y-side end edge of the first reflection film region 14 and the +Y-side end edge of the third bridge portion 143 by the first bonding layer 311. A portion of the third coupling portion 30C facing a groove bottom surface of the −Y-side first groove portion 131C constitutes the displacement portion 301 of the third coupling portion 30C.

The fourth coupling portion 30D has a rectangular shape being long in the X direction, and ±Y-side end portions of the first facing surface 31 are bonded to the +Y-side end edge of the first reflection film region 14 and the −Y-side end edge of the fourth bridge portion 144 by the first bonding layer 311. A portion of the fourth coupling portion 30D facing a groove bottom surface of the +Y-side first groove portion 131D constitutes the displacement portion 301 of the fourth coupling portion 30D.

As described above, the first bonding layer 311 that bonds the coupling portion 30 and the first substrate 10 is formed of Au or the like having conductivity. Then, the second extraction electrode 421 provided at the extending portion 144A of the fourth bridge portion 144 is coupled to the first bonding layer 311 that bonds the fourth coupling portion 30D and the fourth bridge portion 144. Note that, when the first bonding layer 311 and the second extraction electrode 421 are formed of the same material such as, for example, an Au film, the first bonding layer 311 and the second extraction electrode 421 may be simultaneously formed.

More specifically, as illustrated in FIG. 2, each of the coupling portions 30 includes a thin plate portion 33 covering the first groove portion 131, and a column portion 34 protruding from the thin plate portion 33 to the second substrate 20 side. Note that, in the present embodiment, as illustrated in FIG. 6, the thin plate portion 33 and the column portion 34 are formed separately from each other, but may be formed integrally.

In the present embodiment, the thin plate portion 33 and the column portion 34 are formed of a conductive material. For example, the thin plate portion 33 is formed of Si, and the column portion 34 is formed of an Au film. Thus, the coupling portions 30 are conducted to each other via the second substrate 20. In this way, the four coupling portions 30 can have the same potential.

As described above, the thin plate portion 33 is bonded to the first substrate 10 by the first bonding layer 311 formed of Au or the like, and a central portion of the thin plate portion 33 faces the groove bottom surface of the first groove portion 131 of the first substrate 10 via a second gap G2.

The column portion 34 is provided at the center of the thin plate portion 33 in a width direction in plan view. In other words, the column portion 34 of the first coupling portion 30A and the second coupling portion 30B is provided in a position inside ±X-side end edges of the thin plate portion 33 by a predetermined dimension, and the column portion 34 of the third coupling portion 30C and the fourth coupling portion 30D is provided in a position inside ±Y-side end edges of the thin plate portion 33 by a predetermined dimension.

Then, the second facing surface 32 (a protruding tip surface) of the column portion 34 is bonded to the second substrate 20 by a second bonding layer 341 of, for example, Au or the like having conductivity. In the present embodiment, the column portion 34 formed of the Au film and the second bonding layer 341 provided at the second substrate 20 are bonded by room-temperature activation bonding.

In such a present embodiment, the thin plate portion 33 and the column portion 34 of the coupling portion 30 are formed of the conductive material, and thus the coupling portion 30 itself can function as an electrode. In other words, the coupling portion 30 according to the present embodiment functions as a second driving electrode facing the first driving electrode 41 via the second gap G2, and also functions as the driving unit 40.

Note that the present embodiment illustrates an example in which the coupling portion 30 is formed of Si having conductivity, but the coupling portion 30 may be formed of an insulator. In this case, a second driving electrode facing the first driving electrode 41 may be separately formed at the first facing surface 31 of the coupling portion 30. When the second driving electrode is separately formed, the second driving electrode in each of the coupling portions 30 is coupled to the second substrate 20 formed of Si, and any of the second driving electrodes (for example, the second driving electrode provided at the fourth coupling portion 30D) is coupled to the second extraction electrode 421. Alternatively, when the second substrate 20 is formed of an insulator, an electrode layer of ITO or the like may be formed at a front surface of the second substrate 20, and may be coupled to each of the second driving electrodes.

5. Configuration of Driving Unit

The driving unit 40 is driven by a control circuit 90, and changes a dimension of the second gap G2 by bending the coupling portion 30 to the groove bottom surface side of the first groove portion 131 of the first substrate 10. In the present embodiment, the driving unit 40 is an electrostatic actuator, and is formed of the first driving electrode 41 provided at the first substrate 10, and the coupling portion 30 as described above.

In the present embodiment, since each of the coupling portions 30 having conductivity is bonded to the second substrate 20 having conductivity by the second bonding layer 341 having conductivity, the coupling portions 30 each have the same potential. Then, in the present embodiment, each of the coupling portions 30 is maintained at a predetermined reference potential via the second extraction electrode 421.

Therefore, a driving voltage can be applied between the first driving electrode and the coupling portion 30 by controlling a potential of the first driving electrode 41. In this way, electrostatic attraction acts between the first driving electrode 41 and the coupling portion 30, the displacement portion 301 of the coupling portion 30 is bent toward the groove bottom surface of the first groove portion 131, and the second gap G2 changes.

6. Driving of Variable Wavelength Interference Filter

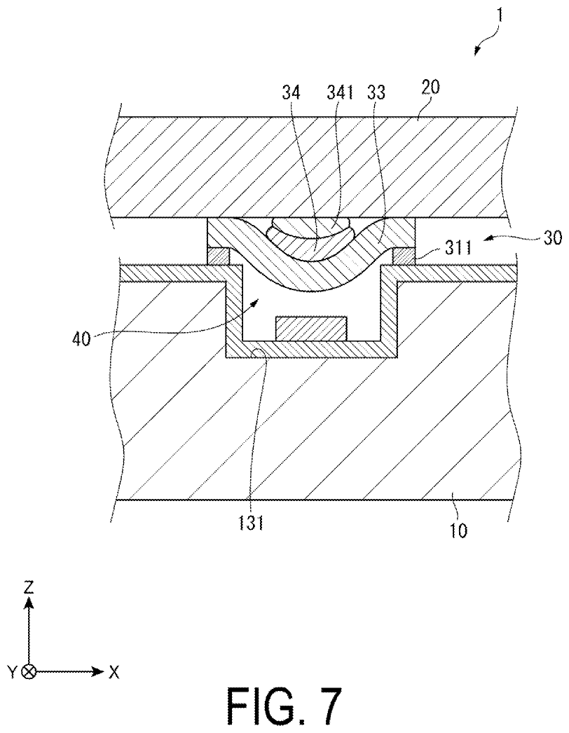

FIG. 7 is an enlarged cross-sectional view of the vicinity of the coupling portion 30 when the coupling portion 30 is bent by the driving unit 40.

In the variable wavelength interference filter 1 as described above, the first extraction electrode 411 and the second extraction electrode 421 are coupled to the control circuit 90 (a driver circuit) that controls the variable wavelength interference filter 1. The control circuit 90 includes a driving control unit 91 that controls a driving voltage applied between the first driving electrode 41 and the coupling portion 30 that constitute the driving unit 40 being the electrostatic actuator. For example, in the present embodiment, the driving control unit 91 maintains the coupling portion 30 at a predetermined reference potential, and changes a potential of the first driving electrode 41 according to a wavelength of light transmitted through the variable wavelength interference filter 1. In this way, as described above, the displacement portion 301 of the coupling portion 30 is bent to the groove bottom surface side of the first groove portion 131, and the second gap G2 changes.

By the second gap G2 changing, the second substrate 20 bonded to the column portion 34 of the coupling portion 30 moves to the first substrate 10 side. In this way, the dimension of the first gap G1 between the first reflection film 51 and the second reflection film 52 changes.

Further, a dimension in the Z direction from the second facing surface 32 of the thin plate portion 33 to a protruding tip (the second facing surface 32) of the column portion 34 is shorter than an initial dimension of the first gap G1 in a state (initial position) where the second substrate 20 is not moved by the driving unit 40. In this case, before the first reflection film 51 and the second reflection film 52 collide with each other, the second substrate 20 abuts the second facing surface 32 of the thin plate portion 33, and a movement of the second substrate 20 is regulated. In this way, deterioration or breakage of the first reflection film 51 and the second reflection film 52 due to the collision can be suppressed.

In such a present embodiment, the variable wavelength interference filter 1 can transmit light having a desired wavelength with high accuracy.

In other words, in a known configuration in which the first substrate 10 and the second substrate 20 are coupled to each other by, for example, a piezoelectric body, and the first gap G1 is changed by controlling a voltage applied to the piezoelectric body, a thicknesses of the piezoelectric body needs to be increased in order to secure a change amount of the first gap G1. In this case, it is difficult to accurately make the thickness of the piezoelectric body uniform, and it is difficult to maintain parallelism between the first substrate 10 and the second substrate 20. When the parallelism between the first substrate 10 and the second substrate 20 cannot be maintained, a wavelength of light transmitted through the optical region C also varies. Further, the piezoelectric body itself bonded to the second substrate 20 expands and contracts, and thus stress acts on the second substrate 20 in contact with the piezoelectric body, and a bend may also occur in the second substrate 20. In this way, when the bend occurs in the second substrate 20, a gap between the first reflection film 51 and the second reflection film 52 varies in the optical region C.

As described above, in the known configuration in which the first substrate 10 and the second substrate 20 are bonded to each other via the piezoelectric body, the gap between the first reflection film 51 and the second reflection film 52 varies in the optical region C. Thus, light having a wavelength other than a desired wavelength is also transmitted through the variable wavelength interference filter, and a half-value width becomes wide in a transmittance characteristic of the variable wavelength interference filter.

In contrast, in the present embodiment, by the second gap G2 changing, and thus the entire second substrate 20 bonded to the coupling portion 30 is pulled to the first substrate 10 side, and a bend does not occur in the second substrate 20. In other words, in the variable wavelength interference filter 1 according to the present embodiment, the dimension of the first gap G1 can be changed while maintaining parallelism between the first reflection film 51 and the second reflection film 52. In this way, in the variable wavelength interference filter 1 according to the present embodiment, a half-value width can be narrow in a transmittance characteristic, and light having a desired wavelength can be accurately transmitted.

Further, the displacement portion 301 of the coupling portion 30 is deformed by the driving unit 40 formed of the electrostatic actuator, and a thickness does not need to be increased in order to secure a displacement amount unlike the piezoelectric body. In other words, an increase in the thickness of the variable wavelength interference filter 1 can be suppressed.

7. Method for Manufacturing Variable Wavelength Interference Filter

Next, a method for manufacturing the variable wavelength interference filter 1 as described above will be described.

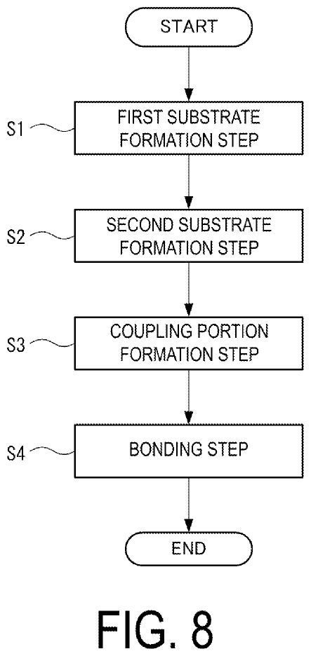

FIG. 8 is a flowchart in the method for manufacturing the variable wavelength interference filter 1 in the present embodiment.

As illustrated in FIG. 8, manufacturing of the variable wavelength interference filter 1 includes a first substrate formation step S1, a second substrate formation step S2, a coupling portion formation step S3, and a bonding step S4. Note that an order of the first substrate formation step S1 and the second substrate formation step S2 may be switched, or the first substrate formation step S1 and the second substrate formation step S2 may simultaneously proceed in different production lines.

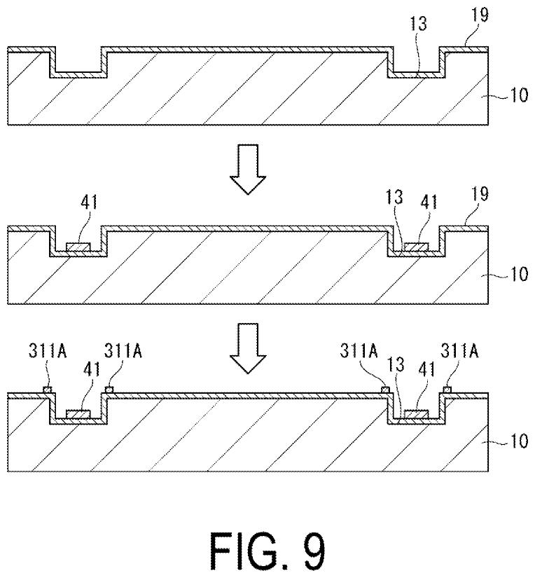

FIG. 9 is a diagram schematically illustrating the first substrate formation step S1.

In the first substrate formation step S1, a resist is formed in a position other than a formation position of the recessed groove 13 with respect to a front surface of a first basic material that serves as a basic material of the first substrate 10, and etching is performed to form the recessed groove 13. Then, after the resist is removed, the insulating layer 19 is formed at the first substrate surface 11 of the first substrate 10 as illustrated in a first diagram in FIG. 9.

Next, after the resist is removed, a conductive film of ITO or the like is formed at the first substrate 10. Then, a mask pattern that covers a formation position of the first driving electrode 41, the first extraction electrode 411, and the second extraction electrode 421 is formed at the conductive film, and the conductive film is etched. In this way, as illustrated in a second diagram in FIG. 9, the first driving electrode 41, the first extraction electrode 411, and the second extraction electrode 421 are formed at the first substrate 10. Note that FIG. 9 illustrates only the first driving electrode 41.

Next, after the mask pattern for electrode formation is removed, a bonding film formed of, for example, Au or the like is film-formed at the first substrate 10.

Then, a mask that covers a formation position of the first bonding layer 311 is formed at the bonding film, and the bonding film is patterned by etching or the like to form a substrate-side first bonding layer 311A as illustrated in a third diagram in FIG. 9.

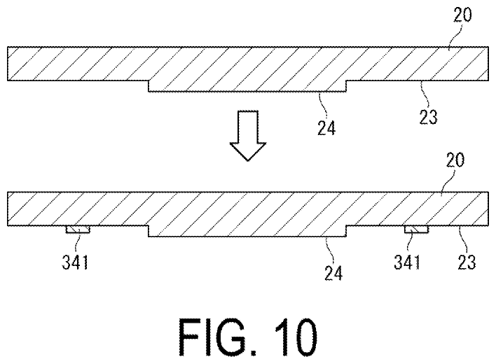

FIG. 10 is a diagram schematically illustrating the second substrate formation step S2.

In the second substrate formation step S2, a resist is formed in a formation position of the second reflection film region 24 with respect to a front surface of a second basic material that serves as a basic material of the second substrate 20, and etching is performed. In this way, as illustrated in a first diagram in FIG. 10, a step is formed between the second reflection film region 24 and the coupling region 23.

Next, after the resist is removed, a bonding film formed of, for example, Au or the like is film-formed at the second substrate 20. Then, a mask pattern that covers a formation position of the second bonding layer 341 is formed at the bonding film, and the bonding film is etched. In this way, as illustrated in a second diagram in FIG. 10, the second bonding layer 341 is formed.

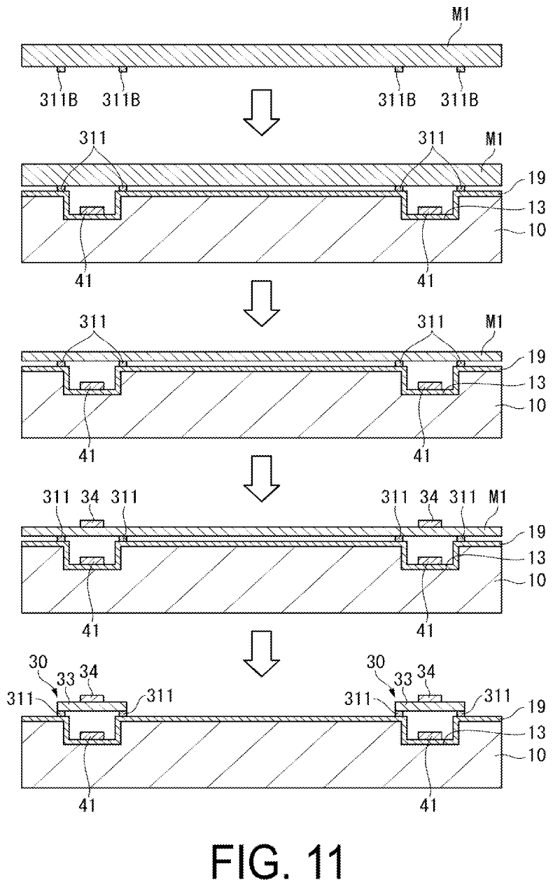

FIG. 11 is a diagram schematically illustrating the coupling portion formation step S3.

In the coupling portion formation step S3, a bonding film formed of, for example, Au or the like is film-formed at a basic material M1 formed of Si having the same size as that of the first substrate 10 in plan view. Then, a mask pattern that covers a formation position of the first bonding layer 311 is formed at the bonding film, and the bonding film is etched. In this way, as illustrated in a first diagram in FIG. 11, a coupling portion-side first bonding layer 311B is formed.

Next, the first substrate 10 formed by the first substrate formation step S1 and the basic material M1 are overlapped and bonded. Specifically, the substrate-side first bonding layer 311A and the coupling portion-side first bonding layer 311B are abutted to be bonded by room-temperature activation bonding, and thus the first bonding layer 311 is formed as illustrated in a second diagram in FIG. 11.

Next, as illustrated in a third diagram in FIG. 11, a thickness of the basic material M1 is set to a thickness of the thin plate portion 33 by polishing the basic metal M1.

Subsequently, a bonding film formed of, for example, Au or the like is film-formed at a surface of the basic material M1 on an opposite side to the first substrate 10. Then, a mask pattern that covers a formation position of the second bonding layer 341 is formed at the bonding film, and the bonding film is etched. In this way, as illustrated in a fourth diagram in FIG. 11, the column portion 34 is formed.

Next, a resist pattern is formed in a position other than an installation position of the coupling portion 30 of the basic material M1, and the thin plate portion 33 as illustrated in a fifth diagram in FIG. 11 is formed by etching.

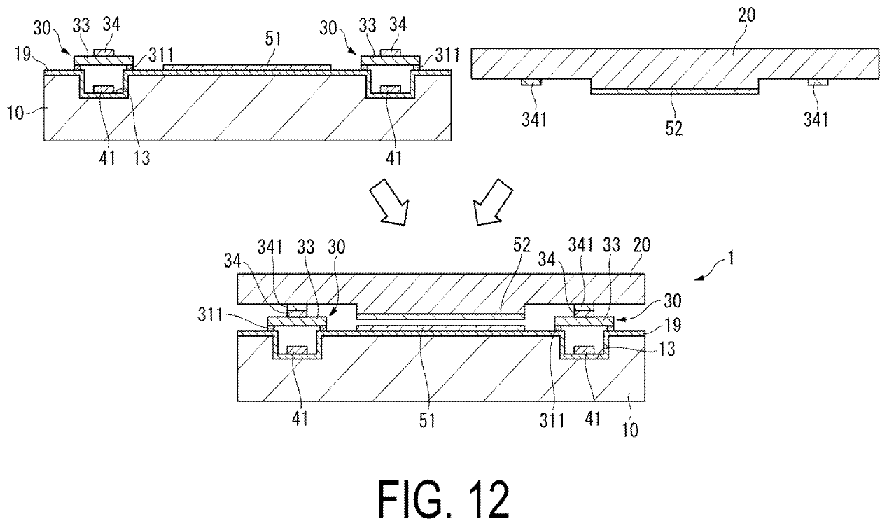

FIG. 12 is a diagram schematically illustrating the bonding step S4.

In the bonding step S4, first, the first reflection film 51 and the second reflection film 52 are formed as illustrated in an upper left diagram and an upper right diagram in FIG. 12. In other words, the first reflection film 51 and the second reflection film 52 are formed immediately before the second substrate 20 is coupled to the first substrate 10 in order to prevent deterioration due to another step. In formation of the first reflection film 51, the first reflection film 51 is formed by, for example, deposition or the like by masking a position other than a formation position of the first reflection film 51 of the first substrate 10 to which the coupling portion 30 is bonded. Note that the first reflection film 51 may be formed after the insulating layer 19 is removed from the region where the first reflection film 51 is formed. Further, in formation of the second reflection film 52, the second reflection film 52 is formed by, for example, deposition or the like by masking a position other than a formation position of the second reflection film 52 of the second substrate 20.

Subsequently, the second substrate 20 is overlapped and bonded to the first substrate 10 to which the coupling portion 30 is bonded. Specifically, the column portion 34 of the coupling portion 30 and the second bonding layer 341 of the second substrate 20 are abutted to be bonded by room-temperature activation bonding. In this way, as illustrated in a lower diagram in FIG. 12, the first substrate 10 and the second substrate 20 are bonded to each other via the coupling portion 30.

8. Effect of First Embodiment

The variable wavelength interference filter 1 according to the present embodiment includes the first substrate 10, the second substrate 20 facing the first substrate 10 via a predetermined gap, the first reflection film 51 installed at the first substrate 10, the second reflection film 52 installed at the second substrate 20, and facing the first reflection film 51 via the predetermined first gap G1, the coupling portion 30 disposed between the first substrate 10 and the second substrate 20, and including the first facing surface 31 facing the first substrate 10 and the second facing surface 32 facing the second substrate 20, and the driving unit 40 configured to change the first gap G1.

A part of the first facing surface 31 of The coupling portion 30 is coupled to the first substrate 10. When viewed from the Z direction from the first substrate 10 toward the second substrate 20, a portion of the first facing surface 31 of the coupling portion 30 not coupled to the first substrate 10 constitutes the displacement portion 301 facing the first substrate 10 via the predetermined second gap G2. The column portion 34 of the displacement portion 301 provided on the second facing surface 32 side is coupled to the second substrate 20. Then, the driving unit 40 changes the second gap G2 by bending the displacement portion 301 to the first groove portion 131 side to change the first gap G1.

In such a configuration, the second substrate 20 advances and retreats with respect to the first substrate 10 in conjunction with a bend of the displacement portion 301 of the coupling portion 30, but a bend does not occur in the second substrate 20 itself. Therefore, the first gap G1 can be changed while maintaining parallelism between the first reflection film 51 and the second reflection film 52. Thus, the first gap G1 in the optical region C does not vary, and light having a desired target wavelength can be accurately emitted from the variable wavelength interference filter 1. In other words, inconvenience that a transmission wavelength changes according to a place in the optical region C can be suppressed, and light having a target wavelength can be uniformly transmitted within a plane of the optical region C.

In the variable wavelength interference filter 1 according to the present embodiment, the driving unit 40 is the electrostatic actuator formed of the first driving electrode 41 installed at the first substrate 10, and the coupling portion 30. In such an electrostatic actuator, the coupling portion 30 is maintained at a reference potential, and a potential of the first driving electrode 41 is controlled, and thus a driving voltage applied between the first driving electrode 41 and the coupling portion 30 can be controlled with high accuracy, and the second gap G2 can be accurately set to a desired dimension. In this way, the first gap G1 can also be accurately set to a dimension corresponding to a desired target wavelength.

In the present embodiment, the coupling portion 30 is formed of silicon (Si). Then, the coupling portion 30 functions as the second driving electrode that pairs up with the first driving electrode 41 in the electrostatic actuator.

In this way, in the present embodiment, the second driving electrode does not need to be separately formed, and a wiring configuration due to this can also be simplified.

Further, the displacement portion 301 of the coupling portion 30 is a portion bent by electrostatic attraction. When the second driving electrode and the extraction electrode of the second driving electrode are formed at the displacement portion 301, the electrode may also be broken or disconnected by stress during deformation of the displacement portion 301. In contrast, in the configuration in which the coupling portion 30 functions as the second driving electrode as in the present embodiment, there is no breakage or disconnection of the electrode as described above, and reliability of the variable wavelength interference filter 1 can be increased.

In the variable wavelength interference filter 1 according to the present embodiment, the coupling portion 30 includes the thin plate portion 33 including the first facing surface 31 and the second facing surface 32, and the column portion 34 protruding from the second facing surface 32 of the thin plate portion 33 toward the second substrate 20 and having the protruding tip portion coupled to the second substrate 20. In this way, the thin plate portion 33 is bonded to the first substrate 10, the column portion 34 is bonded to the second substrate 20, and a portion of the thin plate portion 33 that is not bonded to the first substrate 10 functions as the displacement portion 301. In such a configuration, the column portion 34 is coupled to the second substrate 20, and thus stress due to deformation of the thin plate portion 33 is less likely to propagate to the second substrate 20, and a bend of the second substrate 20 can be suppressed.

In the variable wavelength interference filter 1 according to the present embodiment, the dimension of the column portion 34 in the Z direction is smaller than the initial dimension of the first gap G1 in a state where the displacement portion 301 is not deformed by the driving unit 40.

In this way, when the displacement portion 301 is greatly bent, the second substrate 20 abuts the thin plate portion 33 before the second reflection film 52 collides with the first reflection film 51, and a movement of the second substrate 20 can be regulated. Thus, breakage or deterioration of the first reflection film 51 and the second reflection film 52 due to the collision can be suppressed.

In the variable wavelength interference filter 1 according to the present embodiment, a plurality of the coupling portions 30 are provided in positions that are rotationally symmetrical with respect to the center of the optical region C, and a plurality of the driving units 40 are provided correspondingly to the plurality of coupling portions 30.

In this way, a bend amount of the displacement portion 301 in each of the coupling portions 30 can be controlled by the driving unit 40 provided for each of the coupling portions 30. Thus, an inclination of the second substrate 20 can be more accurately suppressed, and light having a desired target wavelength can be emitted from the variable wavelength interference filter 1 with high accuracy.

### Second Embodiment

Next, a second embodiment will be described.

The first embodiment described above exemplifies the configuration in which the first driving electrode 41 is provided at the groove bottom surface of the first groove portion 131, but another electrode may be further disposed. In the second embodiment, an example in which an electrode other than a first driving electrode 41 is further provided at a first groove portion 131 will be described.

Note that, in the following description, the configuration described above will be denoted by the same reference sign, and description of the configuration will be omitted or simplified.

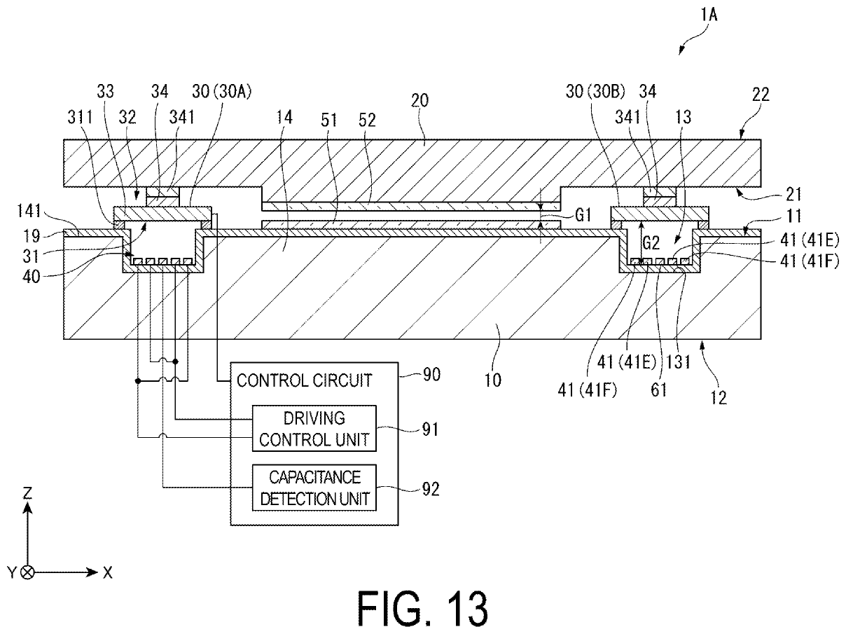

FIG. 13 is a cross-sectional view illustrating a schematic configuration of a variable wavelength interference filter 1A according to a second embodiment.

In the present embodiment, as illustrated in FIG. 13, a first capacitance detection electrode 61 is provided at the first groove portion 131 in addition to the first driving electrode 41. The first capacitance detection electrode 61 is an independent electrode that is not conducted to the first driving electrode 41, and faces a coupling portion 30 maintained at a reference potential. A capacitance extraction electrode (not illustrated) is coupled to the first capacitance detection electrode 61, and the capacitance extraction electrode is extended to an electrical equipment portion 134. The capacitance extraction electrode is coupled to a capacitance detection unit 92 provided at a control circuit 90. The capacitance detection unit 92 measures a dimension of a second gap G2 by detecting capacitance between the first capacitance detection electrode 61 and the coupling portion 30.

Note that, similarly to the first embodiment, the present embodiment exemplifies a configuration in which the coupling portion 30 is formed of a substrate (for example, an Si substrate) having conductivity, but the coupling portion 30 may be formed of an insulator. In this case, a second capacitance detection electrode may be separately formed in a position facing the first capacitance detection electrode 61 on a first facing surface 31 of the coupling portion 30, and the second capacitance detection electrode may be coupled to the capacitance detection unit 92.

In the present embodiment, the first capacitance detection electrodes 61 independent of one another are provided so as to face four coupling portions 30 (a first coupling portion 30A, a second coupling portion 30B, a third coupling portion 30C, and a fourth coupling portion 30D). In this way, in the variable wavelength interference filter 1A according to the present embodiment, the dimension of the second gap G2 in each of the coupling portions 30 can be individually detected by the capacitance detection unit 92. In other words, in the present embodiment, an inclination of a second substrate 20 with respect to a first substrate 10 can be detected by measuring the second gap G2 in each of the coupling portions 30.

Further, in the present embodiment, similarly to the first embodiment, the first driving electrodes 41 independent of one another are provided for the coupling portions 30. Thus, a voltage applied to each of the first driving electrodes 41 can be controlled such that the second substrate 20 is parallel to the first substrate 10 when an inclination of the second substrate 20 with respect to the first substrate 10 is measured. In other words, the control circuit 90 can perform feedback control such that the dimension of the second gap G2 in the four coupling portions 30 detected by the capacitance detection unit 92 is a target dimension corresponding to a desired target wavelength at which the variable wavelength interference filter 1A is transmitted.

Further, the configuration in which the single first driving electrode 41 is provided as the driving unit 40 is exemplified in the first embodiment, but a plurality of the first driving electrodes 41 constituting a driving unit 40 may be provided.

For example, in the second embodiment, an inner first driving electrode 41E and an outer first driving electrode 41F are provided as the first driving electrode 41 constituting the driving unit 40. A pair of the inner first driving electrodes 41E are provided so as to have line symmetry with respect to the center of the first groove portion 131 in the width direction. For example, the first coupling portion 30A and the second coupling portion 30B are provided so as to have line symmetry with respect to a center line passing through the center of the first groove portion 131 in the X direction and being parallel to the Y direction. Further, the third coupling portion 30C and the fourth coupling portion 30D are provided so as to have line symmetry with respect to a center line passing through the center of the first groove portion 131 in the Y direction and being parallel to the X direction.

The same also applies to the outer first driving electrode 41F, and a pair of the outer first driving electrodes 41F are provided positions that are line symmetrical with respect to the center of the first groove portion 131 in the width direction.

In such a configuration, for example, a driving control unit 91 applies a bias voltage to any one of the inner first driving electrode 41E and the outer first driving electrode 41F, and displaces the coupling portion 30 such that the second gap G2 is closer to a target dimension. On the other hand, the driving control unit 91 applies a feedback voltage based on capacitance detected by the capacitance detection unit 92 to the other of the inner first driving electrode 41E and the outer first driving electrode 41F, and finely adjusts a displacement amount of the coupling portion 30.

In this way, the second gap G2 of each of the coupling portions 30 can be accurately adjusted to a desired target dimension.

Effect of the Present Embodiment

The variable wavelength interference filter 1A according to the present embodiment includes the first capacitance detection electrode 61 installed at the first groove portion 131 of the first substrate 10, and the coupling portion 30 also functions as the second capacitance detection electrode facing the first capacitance detection electrode 61.

Thus, in the present embodiment, the dimension of the second gap G2 can be individually measured in a position of each of the coupling portions 30. In this way, an inclination of the second substrate 20 with respect to the first substrate 10 can be detected.

Further, the first driving electrode 41 constituting the driving unit 40 is provided for each of the coupling portions 30. In this way, as described above, feedback control can be individually performed on a voltage applied to each of the first driving electrodes 41, based on the dimension of the second gap G2 measured by the capacitance detection unit 92, and the second substrate 20 can be controlled so as to be changed with respect to the first substrate 10.

Furthermore, in the present embodiment, the first driving electrode 41 includes the inner first driving electrode 41E and the outer first driving electrode 41F, and the inner first driving electrode 41E and the outer first driving electrode 41F can be independently driven. In this case, a bias voltage can be applied to one of the inner first driving electrode 41E and the outer first driving electrode 41F, and a feedback voltage can be applied to the other, and dimension control of the second gap G2 can be more finely adjusted. Thus, the second gap G2 in the position of each of the coupling portions 30 can be finely adjusted to a desired dimension.

### Third Embodiment

Next, a third embodiment will be described.

The second embodiment described above illustrates the example in which the first capacitance detection electrode 61 for measuring the dimension of the second gap G2 is provided at the groove bottom surface of the first groove portion 131. In contrast, in the third embodiment, a capacitance detection electrode for measuring a dimension of a first gap G1 is provided.

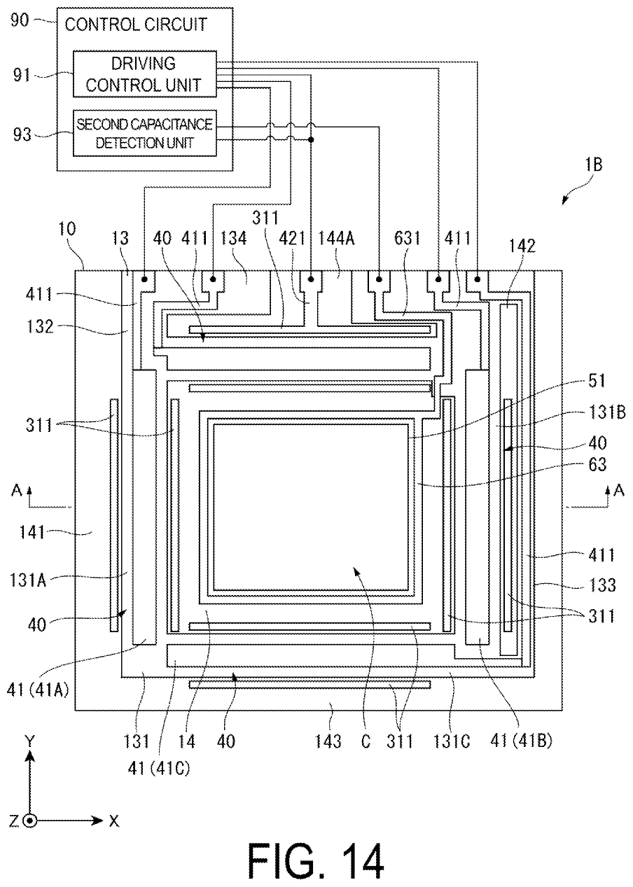

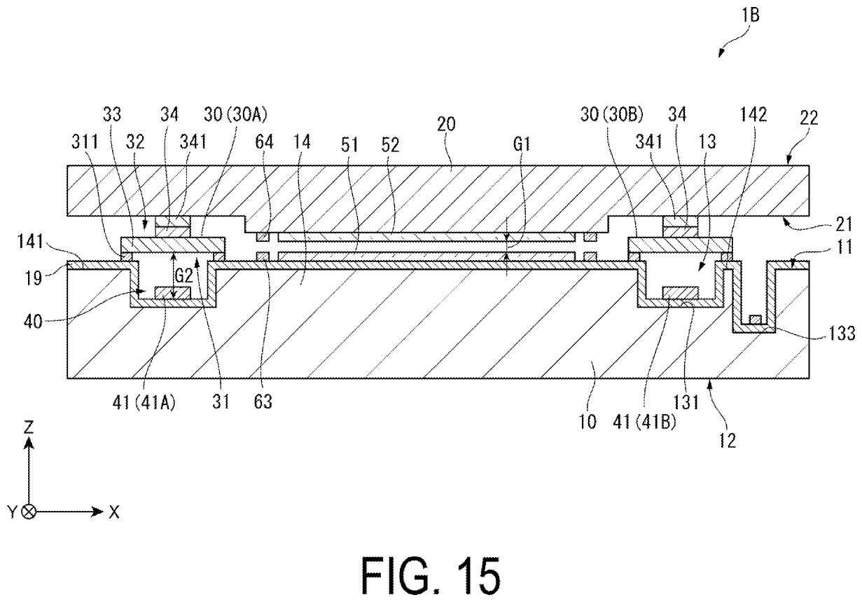

FIG. 14 is a plan view illustrating a schematic configuration of a variable wavelength interference filter 1B according to the third embodiment. FIG. 15 is a cross-sectional view of the variable wavelength interference filter 1B in FIG. 14 taken along an A-A line. Note that illustration of a second substrate 20 and a coupling portion 30 is omitted from FIG. 14 in consideration of clarity of the drawing.

In the present embodiment, a third capacitance detection electrode 63 having a rectangular frame shape is provided along an outer peripheral edge of a first reflection film 51 in a first reflection film region 14 of a first substrate 10. A capacitance extraction electrode 631 extended from a second groove portion 132 to an electrical equipment portion 134 is coupled to the third capacitance detection electrode 63, and is coupled to a control circuit 90 via a lead wire and an FPC in the electrical equipment portion 134.

Further, in the present embodiment, the third capacitance detection electrode 63 is formed so as to have the same thickness as that of the first reflection film 51, and a fourth capacitance detection electrode 64 formed so as to have the same thickness as that of a second reflection film 52 is provided at the second substrate 20 so as to face the third capacitance detection electrode 63.

In other words, since the second substrate 20 is formed of Si having conductivity, the second substrate 20 can also function as the fourth capacitance detection electrode of the present disclosure similarly to the second embodiment. However, in the present embodiment, the dimension of the first gap G1 between the first reflection film 51 and the second reflection film 52 is measured by the third capacitance detection electrode 63 and the fourth capacitance detection electrode 64. In this case, in order to measure an accurate dimension of the first gap G1, the third capacitance detection electrode 63 and the fourth capacitance detection electrode 64 having a thickness equal to a thicknesses of the first reflection film 51 and the second reflection film 52 may be provided. In this way, an accurate dimension of the first gap G1 from a front surface of the first reflection film 51 to a front surface of the second reflection film 52 can be measured with high accuracy.

Since the third capacitance detection electrode 63 and the fourth capacitance detection electrode 64 are not provided in a region overlapping an optical region C, inconvenience that light transmitted through the optical region is inhibited by the third capacitance detection electrode 63 and the fourth capacitance detection electrode 64 can also be suppressed.

Then, the control circuit 90 is provided with a second capacitance detection unit 93, and capacitance between the third capacitance detection electrode 63 and the fourth capacitance detection electrode 64 is detected to measure the dimension of the first gap G1.

In the present embodiment, an accurate dimension of the first gap G1 can be detected by the second capacitance detection unit 93. Thus, feedback control can be performed on a driving voltage applied to each first driving electrode 41 such that the dimension of the first gap G1 is a desired target dimension.

Note that FIGS. 14 and 15 exemplify the configuration in which a driving unit 40 includes the single first driving electrode 41, but the driving unit 40 may include an inner first driving electrode 41E and an outer first driving electrode 41F as described in the second embodiment.

The present embodiment illustrates the configuration example in which the dimension of the first gap G1 is measured by the third capacitance detection electrode 63 and the fourth capacitance detection electrode 64, but a first capacitance detection electrode 61 may be further provided, and a second gap G2 can be measured.

Effect of the Present Embodiment

The variable wavelength interference filter 1B according to the present embodiment further includes the third capacitance detection electrode 63 provided at the first substrate 10, and the fourth capacitance detection electrode 64 provided at the second substrate 20 and facing the third capacitance detection electrode 63. The third capacitance detection electrode 63 is installed in a position surrounding the first reflection film 51 when viewed from the Z direction, and the fourth capacitance detection electrode 64 is installed in a position surrounding the second reflection film 52 when viewed from the Z direction.

Thus, in the present embodiment, the dimension of the first gap G1 can be accurately measured. In other words, in the second embodiment, since the second gap G2 in each of the coupling portions 30 is measured, the dimension of the first gap G1 between the first reflection film 51 and the second reflection film 52 cannot be directly measured. In contrast, in the present embodiment, since the dimension of the first gap G1 can be measured, a wavelength of light transmitted through the variable wavelength interference filter 1B can be adjusted based on the measured dimension of the first gap G1.

### Fourth Embodiment

Next, a fourth embodiment will be described.

The first to third embodiments described above exemplify the configuration in which the driving unit 40 is the electrostatic actuator, and the coupling portion 30 is bent to the groove bottom surface side of the first groove portion 131 by electrostatic attraction. In contrast, in the fourth embodiment, a driving method of the driving unit 40 is different from that of the embodiments described above.

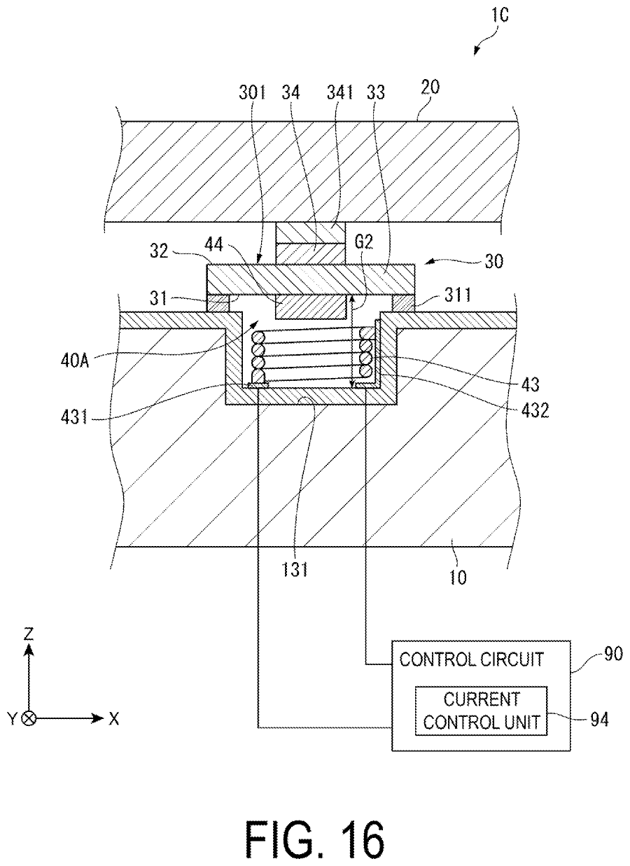

FIG. 16 is a schematic cross-sectional view illustrating a vicinity of a coupling portion 30 of a variable wavelength interference filter 1C in the fourth embodiment.

In the present embodiment, as illustrated in FIG. 16, a driving unit 40A is formed of a coil 43 provided at a groove bottom surface of a first groove portion 131, and a permanent magnet 44 provided at a first facing surface 31 of the coupling portion 30.

Note that FIG. 16 exemplifies a configuration in which the coil 43 is provided at the first groove portion 131 and the permanent magnet 44 is provided at the coupling portion 30, but the permanent magnet 44 may be provided at the first groove portion 131 and the coil 43 may be provided at the coupling portion 30.

The first embodiment described above has the configuration in which the first driving electrode 41 is formed long along the side direction of the first groove portion 131, but the present embodiment may have a configuration in which a plurality of the coils 43 are provided along the side direction of the first groove portion 131, or the like. In this case, the same number of the coils 43 is disposed for each side of the first groove portion 131. For example, when n coils 43 are disposed at a −X-side first groove portion 131A at a predetermined interval along the Y direction, the n coils 43 are also disposed at a +X-side first groove portion 131B at the interval along the Y direction, the n coils 43 are also disposed at a −Y-side first groove portion 131C at the interval along the X direction, and the n coils 43 are also disposed at a +Y-side first groove portion 131D at the interval along the X direction.

The coil 43 is formed with an axis along the Z direction as a central axis.

One end of the coil 43 is coupled to, for example, a first coil electrode 431 provided at the groove bottom surface of the first groove portion 131. Further, the other end of the coil 43 is coupled to, for example, a second coil electrode 432 formed from a side wall to the groove bottom surface of the first groove portion 131. The first coil electrode 431 and the second coil electrode 432 are individually extended to an electrical equipment portion 134, and are coupled from the electrical equipment portion 134 to a current control unit 94 of a control circuit 90. Note that a through hole penetrating a first substrate 10 in the Z direction may be provided at the groove bottom surface of the first groove portion 131, and an electrode wire coupled to the coil may be inserted through the through hole.

For example, the permanent magnet 44 is disposed such that the −Z side toward the first substrate 10 is an N pole, and the +Z side is an S pole.

The current control unit 94 controls a current flowing through the coil 43. In this way, a magnetic flux passing through the central axis of the coil 43 is generated, and a magnetic pole according to a direction in which the current flows is generated on one end side (+Z side) of the coil 43 facing the permanent magnet 44. For example, by flowing the current such that the +Z side of the coil 43 is the S pole, the coupling portion 30 provided with the permanent magnet 44 is bent to the groove bottom surface side of the first groove portion 131, and a second gap G2 can be changed. Further, by the second gap G2 changing, a second substrate 20 moves to the first substrate 10 side, and a first gap G1 also changes similarly to the first embodiment and the like.

Note that, in the present embodiment, the current can also flow such that the +Z side of the coil 43 is the N pole, and, in this case, the coupling portion 30 is bent to the second substrate 20 side by a repulsive force. Therefore, the first gap G1 can also be increased, and light transmitted through the variable wavelength interference filter 1C can be selected from a wavelength region in a wider range.

Effect of the Present Embodiment

In the variable wavelength interference filter 1C according to the present embodiment, the driving unit 40A is formed of the coil 43 provided at the first groove portion 131, and the permanent magnet 44 (magnetic body) provided at the first facing surface 31 of the coupling portion 30.

In such a configuration, a magnetic field can be generated by flowing a current through the coil 43, and a displacement portion 301 provided with the permanent magnet 44 can be displaced by the magnetic field. At this time, intensity of the magnetic field can be controlled by the current flowing through the coil 43, and a dimension of the second gap G2 can be controlled with high accuracy similarly to the first embodiment. Therefore, the first gap G1 can also be controlled to a dimension corresponding to a desired target wavelength with high accuracy, and light having the target wavelength can be accurately transmitted from the variable wavelength interference filter 1C.

In the present embodiment, the displacement portion 301 can also be bent to the second substrate 20 side by a repulsive force by reversing the direction of the current flowing through the coil 43. In other words, in the present embodiment, the first gap G1 can also be changed so as to be reduced from an initial dimension, or can also be changed so as to be increased from the initial dimension. In this way, light having a desired target wavelength can be transmitted from a wide wavelength region.

### Fifth Embodiment

Next, a fifth embodiment will be described.

The fourth embodiment described above exemplifies the configuration in which the driving unit 40A includes the coil 43 and the permanent magnet 44, and the coil 43 and the permanent magnet 44 are disposed so as to face each other. In contrast, a solenoid may be used as a configuration in which the coupling portion 30 is deformed by using a magnetic force.

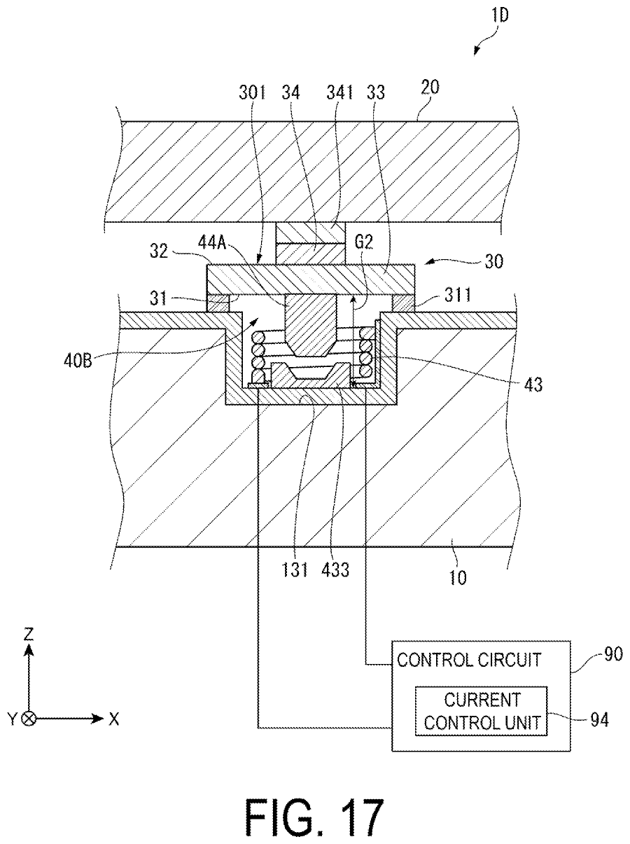

FIG. 17 is a schematic cross-sectional view illustrating a vicinity of a coupling portion 30 of a variable wavelength interference filter 1D in the fifth embodiment.

Similarly to the fourth embodiment, a driving unit 40B according to the present embodiment is provided with a coil 43 at a first groove portion 131, and a fixed magnetic body 433 is disposed on the −Z side of the coil 43.

Further, the coupling portion 30 is provided with a shaft member 44A formed of a magnetic body inserted through the center of the coil 43.

In such a configuration, the shaft member 44A moves toward the fixed magnetic body 433 by flowing a current through the coil 43. In this way, the coupling portion 30 coupled to the shaft member 44A is bent to a groove bottom surface side of the first groove portion 131, and a second gap G2 changes. Further, the shaft member 44A abuts the fixed magnetic body 433, and thus a movement of the coupling portion 30 is regulated, and a collision between a first reflection film 51 and a second reflection film 52 can be suppressed.

Effect of the Present Embodiment

The variable wavelength interference filter 1D according to the present embodiment can achieve an effect similar to that in the fourth embodiment. In other words, the driving unit 40B includes the coil 43 provided at the first groove portion 131, and the shaft member 44A provided at a first facing surface 31 of the coupling portion 30 and inserted through the coil 43.

In such a configuration, the shaft member 44A can be moved in the Z direction by flowing a current through the coil 43 and generating a magnetic field. Also, in this case, intensity of the magnetic field can be controlled by the current flowing through the coil 43, and thus a dimension of the second gap G2 can be controlled with high accuracy.

### Sixth Embodiment

Next, a sixth embodiment will be described.

The first to third embodiments described above exemplify the driving unit 40 formed of the electrostatic actuator. The fourth embodiment and the fifth embodiment exemplify the driving units 40A and 40B that deform the coupling portion 30 by generating a magnetic field. In the sixth embodiment, a configuration in which a coupling portion 30 is bent by using a piezoelectric element will be further described.

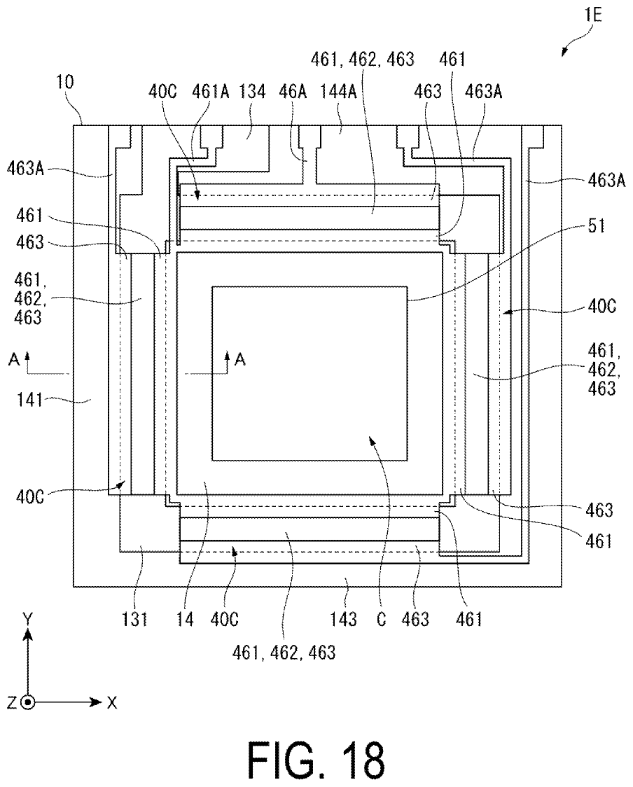

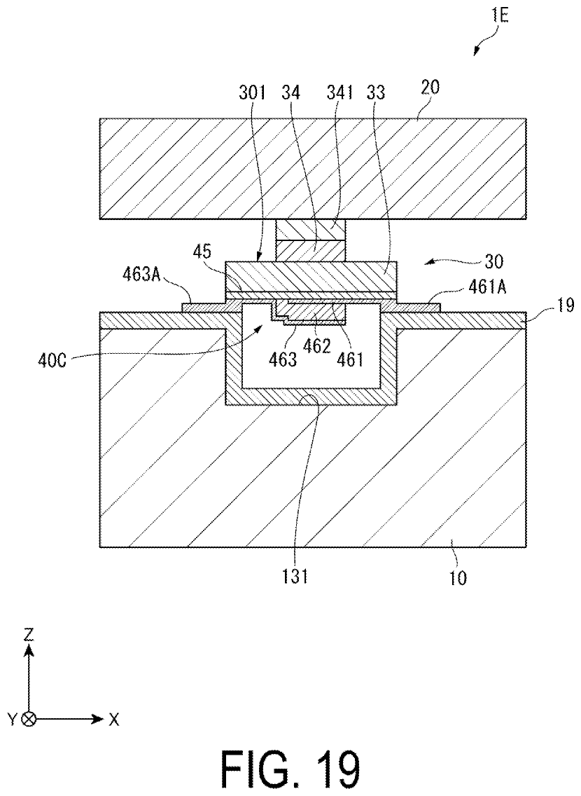

FIG. 18 is a plan view illustrating a schematic configuration of a variable wavelength interference filter 1E according to the sixth embodiment. FIG. 19 is a schematic cross-sectional view of the variable wavelength interference filter 1E taken along an A-A line in FIG. 18. Note that illustration of a second substrate 20 and the coupling portion 30 will be omitted from FIG. 18 in consideration of clarity of the drawing.

In the present embodiment, as illustrated in FIG. 19, an insulating layer 45 is formed at a first facing surface 31 of the coupling portion 30, and a first electrode 461, a piezoelectric film 462, and a second electrode 463 are stacked at the insulating layer 45 along the Z direction. In the present embodiment, a driving unit 40C is formed of the first electrode 461, the piezoelectric film 462, and the second electrode 463.

Herein, as illustrated in FIG. 18, each of the first electrodes 461 of four coupling portions 30 is coupled to, for example, a first extraction electrode 461A provided at a first reflection film region 14, and the first extraction electrode 461A is extended to, for example, a +Y-side end portion of a first substrate 10.

On the other hand, as illustrated in FIG. 18, each of the second electrodes 463 is coupled to an independent second extraction electrode 463A, and is extended to, for example, the +Y-side end portion of the first substrate 10.

Note that, as illustrated in FIG. 19, each of the first extraction electrode 461A and the second extraction electrode 463A may function as a first bonding layer that couples the first substrate 10 and the coupling portion 30.

In such a present embodiment, a predetermined reference potential is applied to the first electrodes 461 coupled to each other as a common electrode, and a driving signal according to a dimension of a first gap G1 is applied to the second electrode 463. In this way, a driving voltage is applied between the first electrode 461 and the second electrode 463, and thus the piezoelectric film 462 is deformed, the coupling portion 30 is bent toward a groove bottom surface of a first groove portion 131, and a second gap G2 changes.

Effect of the Present Embodiment

In the present embodiment, the driving unit 40C includes the first electrode 461 installed at the first facing surface 31, the piezoelectric film 462 installed at the first electrode 461, and the second electrode 463 installed at the piezoelectric film 462, and the first electrode 461, the piezoelectric film 462, and the second electrode 463 are stacked along the Z direction.

In such a driving unit 40C, when a driving voltage is applied between the first electrode 461 and the second electrode 463, the piezoelectric film 462 expands and contracts. For example, in a case in which the piezoelectric film 462 expands when a driving voltage is applied such that a potential of the first electrode 461 is higher than a potential of the second electrode 463, a surface of the piezoelectric film 462 on the coupling portion 30 side is bonded to the coupling portion 30 via the first electrode 461, and thus has an expansion amount smaller than that of a surface of the piezoelectric film 462 on the first substrate 10 side. Thus, the piezoelectric film 462 is bent toward the groove bottom surface side of the first groove portion 131. In this way, a displacement portion 301 of the coupling portion 30 is also bent toward the groove bottom surface side of the first groove portion 131. Further, a bend amount of the piezoelectric film 462 can be easily controlled by a driving voltage applied to the piezoelectric film 462. Therefore, similarly to the first embodiment described above, a dimension of the second gap G2 can be controlled with high accuracy. In this way, the first gap G1 can also be controlled to a dimension corresponding to a desired target wavelength with high accuracy.

Further, in the present embodiment, a bend direction of the piezoelectric film 462 can be reversed by reversing a driving voltage applied to the piezoelectric film 462. For example, in a case in which the piezoelectric film 462 expands when a driving voltage is applied such that the potential of the first electrode 461 is higher than the potential of the second electrode 463, the piezoelectric film 462 contracts by applying a driving voltage such that the potential of the first electrode 461 is lower than the potential of the second electrode 463. In this case, the surface of the piezoelectric film 462 on the coupling portion 30 side is bonded to the coupling portion 30 via the first electrode 461, and thus has a contraction amount smaller than that of the surface of the piezoelectric film 462 on the first substrate 10 side. Thus, the piezoelectric film 462 is bent toward the second substrate 20. In this way, the displacement portion 301 of the coupling portion 30 is also bent toward the second substrate 20. Thus, similarly to the fourth embodiment and the fifth embodiment, light having a desired target wavelength can be transmitted from a wide wavelength region in the variable wavelength interference filter 1E according to the present embodiment.

### Seventh Embodiment

Next, a seventh embodiment will be described.

The first to sixth embodiments described above illustrate the configuration in which the coupling portion 30 is provided at each of the four sides of the first groove portion 131 having the rectangular frame shape, that is, the configuration example in which the plurality of coupling portions 30 are provided so as to have rotational symmetry with respect to the center of the optical region C.

In contrast, the first groove portion 131 may be formed in an annular shape, and a coupling portion that covers the first groove portion 131 may be provided.

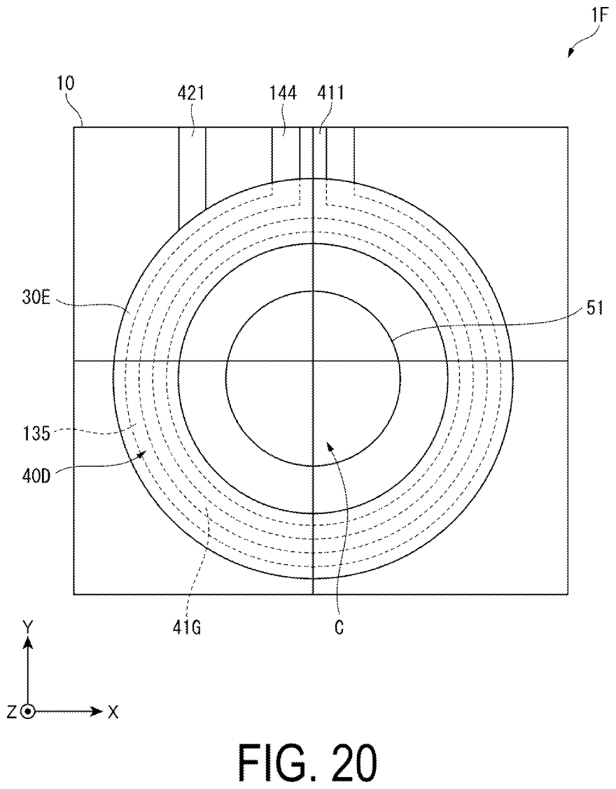

FIG. 20 is a plan view illustrating a schematic configuration of a variable wavelength interference filter 1F according to the seventh embodiment. Note that illustration of a second substrate 20 is omitted from FIG. 20.

In the present embodiment, a first groove portion 135 having an annular shape with a central point (central point of an optical region C) of a first reflection film 51 as the center is included.

Further, a coupling portion 30E is formed in an annular shape that covers the first groove portion 135 in plan view. In other words, as illustrated in FIG. 20, the coupling portion 30E is provided so as to bridge an inner diameter side and an outer diameter side of the first groove portion 135.

Similarly to the first embodiment, a driving unit 40D bends the coupling portion 30E by electrostatic attraction, but, in the present embodiment, a first driving electrode 41G constituting the driving unit 40D is formed in an annular shape surrounding the optical region C.

Effect of the Present Embodiment

In the variable wavelength interference filter 1F according to the present embodiment, the coupling portion 30E is formed in an annular shape surrounding the optical region C, and the driving unit 40D is formed in the annular shape surrounding the optical region C in a position overlapping the coupling portion 30E.

The first groove portion 131 as in the first embodiment described above has the rectangular frame shape, and thus, when the coupling portion 30 is provided at a corner portion, a difference is generated in a bend amount. Thus, a configuration in which an independent coupling portion 30 is provided for each of the sides of the first groove portion 131 is needed. In contrast, as in the present embodiment, when the first groove portion 135 has the annular shape and the first groove portion 135 is covered with the coupling portion 30E having the annular shape, the coupling portion 30E can be uniformly bent over a circumferential direction of the annular shape.

Therefore, the first driving electrode 41G constituting the driving unit 40D has the annular shape, and thus uniform electrostatic attraction can act over the circumferential direction of the coupling portion 30E, and a dimension of a second gap G2 can be changed while suppressing an inclination of the second substrate 20.

Further, in the present embodiment, a plurality of first extraction electrodes 411 does not need to be provided, and simplification of the configuration can be achieved.

### Eighth Embodiment

Next, as an eighth embodiment, an electronic device including the variable wavelength interference filter 1, 1A, 1B, 1C, 1D, or 1E as described in the first to sixth embodiments described above will be described.

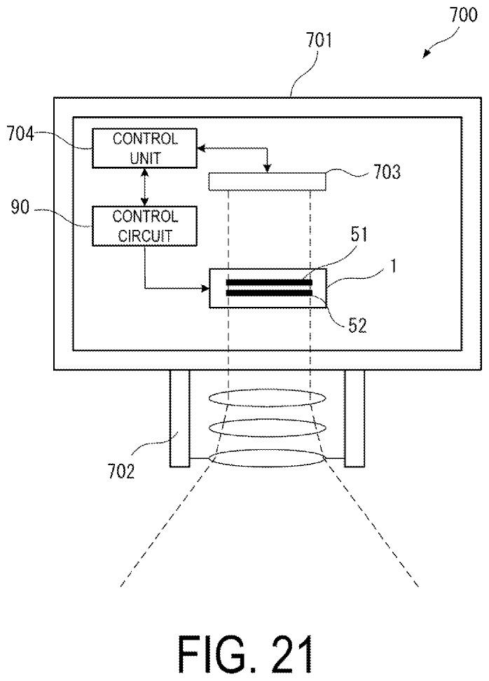

FIG. 21 is a diagram illustrating a schematic configuration of a spectral camera 700 in the eighth embodiment.

As illustrated in FIG. 21, the spectral camera 700 includes a camera main body portion 701 and a lens tube portion 702, and the variable wavelength interference filter 1, a light-receiving unit 703, a control circuit 90, a control unit 704, and the like are housed in the camera main body portion 701. In FIG. 21, the variable wavelength interference filter 1 is used, but any of the variable wavelength interference filters 1A, 1B, 1C, 1D, 1E, and 1F described in the second to sixth embodiment may be used. Further, the variable wavelength interference filter 1 may be incorporated into the camera main body portion 701 while being separately stored in a package housing or the like.

In the spectral camera 700, an incidence optical system formed of a plurality of lenses is housed in the lens tube portion 702, and light having a predetermined angle of view is guided to the light-receiving unit 703 via the variable wavelength interference filter 1.

The light-receiving unit 703 is an image sensor that receives light transmitted through the variable wavelength interference filter 1, and receives light transmitted through the optical region C of the variable wavelength interference filter 1.

The control circuit 90 is a circuit for driving the variable wavelength interference filter 1, and includes the driving control unit 91 and the like as described above. When the variable wavelength interference filter 1A is used, the capacitance detection unit 92 is further provided at the control circuit 90. When the variable wavelength interference filter 1B is used, the second capacitance detection unit 93 is provided. When the variable wavelength interference filter 1C or 1D is used, the current control unit 94 may be provided instead of the driving control unit 91.

The control unit 704 controls an operation of the spectral camera 700, and outputs a command signal according to a target wavelength to the control circuit 90 when an operation signal for acquiring a spectral image having a predetermined target wavelength is input based on, for example, an operation of a user. In this way, the control circuit 90 applies a driving voltage according to a target wavelength to the driving unit 40 of the variable wavelength interference filter 1.

Further, the control unit 704 controls the light-receiving unit 703 to cause the light-receiving unit 703 to perform light-receiving processing, and generates image data (spectral image), based on an output signal for each pixel output from the light-receiving unit 703.

### Modification Example

Note that the present disclosure is not limited to the embodiments described above, and variations, modifications, and the like within the scope in which the object of the present disclosure can be achieved are included in the present disclosure.

### First Modification Example

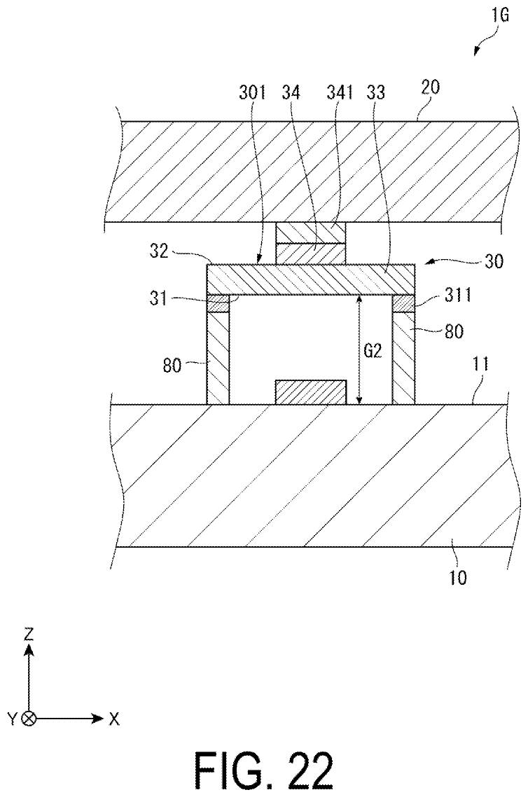

FIG. 22 is a cross-sectional view illustrating a vicinity of the coupling portion 30 of a variable wavelength interference filter 1G according to a first modification example.

The first embodiment described above exemplifies the configuration in which the first groove portion 131 is provided at the first substrate 10 and the coupling portion 30 is disposed so as to cover the first groove portion 131. In contrast, the first substrate 10 may be a plate member having a uniform thickness dimension, and, for example, a pair of holding bases 80 that hold the coupling portion 30 may be provided at the first substrate surface 11 as illustrated in FIG. 22.

### Second Modification Example

The first embodiment exemplifies the configuration in which the second substrate 20 includes the second reflection film region 24, and the coupling region 23 surrounding the second reflection film region 24 and having a thickness smaller than that of the second reflection film region 24. In contrast, the coupling region 23 and the second reflection film region 24 may be formed so as to have the same thickness. In other words, the second substrate surface 21 of the coupling region 23 and the second substrate surface 21 of the second reflection film region 24 may be flush with each other.

Further, the first reflection film region 14 of the first substrate 10 may be formed so as to protrude to the second substrate 20 side, or the first reflection film region 14 may be formed in a recessed shape by etching or the like.

In other words, a position of the first reflection film region 14 in the first substrate 10 and a position of the second reflection film region 24 in the second substrate 20 in the Z direction may be appropriately changed according to a wavelength region of light transmitted through the variable wavelength interference filter 1.

### Third Modification Example

Each of the embodiments described above illustrates the example in which the coupling portion 30 is formed separately from the first substrate 10 and the second substrate 20, but a part or the whole of the coupling portion 30 may be formed integrally with the first substrate 10 or the second substrate 20.

For example, the column portion 34 of the coupling portion 30 may be formed integrally with the second substrate 20. Alternatively, the thin plate portion 33 and the column portion 34 of the coupling portion 30 may be formed integrally with the second substrate 20.

Fourth Modification

The seventh embodiment exemplifies the configuration in which the coupling portion 30E and the driving unit 40D are formed in the annular shape, but, similarly to the first embodiment and the like, a plurality of coupling portions and driving units may be provided so as to have rotational symmetry with respect to the central point of the optical region C.

For example, a plurality of coupling portions having an arc shape may be provided so as to have rotational symmetry with respect to the central point of the optical region C. In this case, a driving unit may be provided for each of the coupling portions having the arc shape. For example, the first driving electrode 41 having an arc shape may be provided at the first groove portion 135 so as to have rotational symmetry with respect to the central point of the optical region C.

Further, the first to sixth embodiments illustrate the example in which the coupling portion 30 is provided for each of the sides of the first groove portion 131 having the rectangular frame shape, and the driving units 40, 40A, and 40B are provided for each of the coupling portions 30, but the shape of the first groove portion 131 is not limited to the rectangular shape, and may be, for example, a triangular frame shape or a polygonal frame shape having five or more corners.

Furthermore, the first groove portion 131 does not need to be formed in the frame shape, and a plurality of groove portions may be provided so as to have rotational symmetry with respect to the center of the optical region C in plan view, and a coupling portion may be installed for each of the grooves.

### Fifth Modification Example

In the eighth embodiment, the spectral camera 700 is exemplified as an example of an electronic device including a variable wavelength interference filter, which is not limited thereto. As the electronic device including the variable wavelength interference filter 1, for example, a light source device (for example, a laser light source device) that outputs light having a desired wavelength, a spectral analysis device that analyzes a contained component of a measured object, a color measurement device that is mounted at a printer or the like and measures a color of a target object, or the like may be used. The light source device or the analysis device may be mounted at a wearable device or the like.

In addition, a specific structure in carrying out the present disclosure can be appropriately changed to another structure or the like within a range in which the object of the present disclosure can be achieved.

Summary of Present Disclosure

A variable wavelength interference filter according to one aspect of the present disclosure includes a first substrate, a second substrate facing the first substrate via a predetermined gap, a first reflection film installed at the first substrate, a second reflection film installed at the second substrate, and facing the first reflection film via a predetermined first gap, a coupling portion disposed between the first substrate and the second substrate, and including a first facing surface facing the first substrate and a second facing surface facing the second substrate, and a driving unit configured to change the first gap, where a part of the first facing surface of the coupling portion is coupled to the first substrate, when viewed from a thickness direction from the first substrate toward the second substrate, a portion of the first facing surface of the coupling portion not coupled to the first substrate constitutes a displacement portion facing the first substrate via a predetermined second gap, a part of the second facing surface of the displacement portion is coupled to the second substrate, and the driving unit changes the second gap by bending the displacement portion, thereby changing the first gap.

In this way, the second substrate advances and retreats with respect to the first substrate in conjunction with a bend of the displacement portion of the coupling portion, and a bend does not occur in the second substrate itself. Therefore, the first gap can be changed while maintaining parallelism between the first reflection film and the second reflection film, and thus the first gap does not vary, and light having a desired target wavelength can be accurately emitted from the variable wavelength interference filter.

In the variable wavelength interference filter according to the present aspect, the driving unit includes a first driving electrode installed at the first substrate, and a second driving electrode installed at the displacement portion and facing the first driving electrode via the second gap.

In the present aspect, the second gap can be changed by deforming the displacement portion by electrostatic attraction by applying a voltage between the first driving electrode and the second driving electrode. At this time, when the second driving electrode is set to have a predetermined reference potential, a driving voltage applied between the electrodes can be controlled easily and with high accuracy by controlling a potential of the first driving electrode, and the dimension of the second gap can be accurately controlled. In this way, the dimension of the first gap can also be properly set to a dimension corresponding to a desired target wavelength.

In the variable wavelength interference filter according to the present aspect, the coupling portion is formed of silicon, and the coupling portion also functions as the second driving electrode.

In such a configuration, since the second driving electrode does not need to be separately formed at the displacement portion, and a wiring configuration due to this is also not necessary, simplification of the configuration can be achieved. When the electrode is formed at a portion deformed by a driving force such as the displacement portion, the electrode may be broken or disconnected by stress during deformation of the displacement portion. In contrast, in the present aspect, the coupling portion itself functions as the second driving electrode, and thus there is no breakage or disconnection of the electrode, and reliability of the variable wavelength interference filter can be increased.

In the variable wavelength interference filter according to the present aspect, the driving unit may include a coil provided at any one of a surface of the first substrate facing the displacement portion and the first facing surface, and a magnetic body provided at the other of the surface of the first substrate facing the displacement portion and the first facing surface.

In the present aspect, a magnetic field can be generated by flowing a current through the coil, and a displacement portion provided with the magnetic body can be displaced by the magnetic field. At this time, intensity of the magnetic field can be controlled by the current flowing through the coil, and the dimension of the second gap can be controlled with high accuracy. Therefore, the first gap can also be controlled to a dimension corresponding to a desired target wavelength with high accuracy, and light having the target wavelength can be accurately transmitted from the variable wavelength interference filter.

In the present aspect, the displacement portion can be bent to the second substrate side by a repulsive force by reversing the direction of the current flowing through the coil, and the variable wavelength interference filter can transmit light having a desired target wavelength from a wider wavelength region.

In the variable wavelength interference filter according to the present aspect, the driving unit may include a first electrode installed at the first facing surface, a piezoelectric film installed at the first electrode, and a second electrode installed at the piezoelectric film, and the first electrode, the piezoelectric film, and the second electrode may be stacked along the thickness direction.

In the present aspect, when a driving voltage is applied between the first electrode and the second electrode, the piezoelectric film expands and contracts, and thus the displacement portion of the coupling portion can be bent. At this time, a bend amount can be more easily controlled by a driving voltage applied to the piezoelectric film, and the dimension of the second gap G2 can be controlled with high accuracy similarly to the aspect described above. In this way, the first gap G1 can also be controlled to a dimension corresponding to a desired target wavelength with high accuracy.

In the variable wavelength interference filter according to the present aspect, the coupling portion includes a thin plate portion including the first facing surface and the second facing surface, and a column portion protruding from the second facing surface of the thin plate portion toward the second substrate and having a protruding tip portion coupled to the second substrate.

In the present aspect, the thin plate portion is bonded to the first substrate, the column portion is bonded to the second substrate, and a portion of the thin plate portion that is not bonded to the first substrate functions as the displacement portion. In such a configuration, the column portion formed at the thin plate portion is coupled to the second substrate, and thus stress due to deformation of the thin plate portion is less likely to propagate to the second substrate, and a bend of the second substrate can be suppressed.

In the variable wavelength interference filter according to the present aspect, a dimension of the column portion in the thickness direction is smaller than an initial dimension of the first gap in a state where the displacement portion is not deformed by the driving unit.

In the present aspect, when the displacement portion is greatly bent, the second substrate abuts the thin plate portion before the second reflection film collides with the first reflection film, and a movement of the second substrate can be regulated. In this way, breakage or deterioration of the first reflection film or the second reflection film due to the collision can be suppressed.

The variable wavelength interference filter according to the present aspect may further include a first capacitance detection electrode installed at the first substrate, and a second capacitance detection electrode provided at the first facing surface and facing the first capacitance detection electrode.

In the present aspect, the dimension of the second gap can be measured by detecting capacitance between the first capacitance detection electrode and the second capacitance detection electrode. Further, when a plurality of the coupling portions are provided around the first reflection film of the first substrate, the dimension of the second gap in a position of each of the coupling portions can be individually measured. In this way, an inclination of the second substrate with respect to the first substrate can be detected.

The variable wavelength interference filter according to the present aspect may further include a third capacitance detection electrode provided at the first substrate, and a fourth capacitance detection electrode provided at the second substrate and facing the third capacitance detection electrode, wherein the third capacitance detection electrode may be installed in a position surrounding the first reflection film when viewed from the thickness direction, and the fourth capacitance detection electrode may be installed in a position surrounding the second reflection film when viewed from the thickness direction.

In the present aspect, the dimension of the second gap can be measured by detecting capacitance between the third capacitance detection electrode and the fourth capacitance detection electrode. Further, as described above, in the present aspect, the second substrate can advance and retreat with respect to the first substrate while maintaining parallelism of the second substrate with respect to the first substrate. Thus, the third capacitance detection electrode may not be provided at the first reflection film, and the fourth capacitance detection electrode may not be provided at the second reflection film. In other words, even when the third capacitance detection electrode is provided around the first electrode and the fourth capacitance detection electrode is provided around the second reflection film, the first gap can be accurately measured. Since the third capacitance detection electrode and the fourth capacitance detection electrode are not provided in the optical region where the first reflection film and the second reflection film overlap each other in the thickness direction, inconvenience that light transmitted through the optical region is inhibited by the third capacitance detection electrode and the fourth capacitance detection electrode can also be suppressed.

In the variable wavelength interference filter according to the present aspect, provided that a region where the first reflection film and the second reflection film overlap each other when viewed from the thickness direction is an optical region, the coupling portion may be formed in an annular shape surrounding the optical region, and the driving unit may be formed in the annular shape surrounding the optical region in a position overlapping the coupling portion.

In such a configuration, the driving unit can bend the displacement portion of the coupling portion by applying uniform stress along the circumferential direction to the coupling portion having the annular shape surrounding the optical region. In this way, the first gap can be changed with high accuracy while maintaining parallelism between the first reflection film and the second reflection film.

In the variable wavelength interference filter according to the present aspect, provided that a region where the first reflection film and the second reflection film overlap each other when viewed from the thickness direction is an optical region, a plurality of the coupling portions may be provided in positions that are rotationally symmetrical with respect to the center of the optical region, and a plurality of the driving units may be provided correspondingly to the plurality of coupling portions.

In the present aspect, the coupling portion is provided in the position having rotational symmetry with respect to the center of the optical region, and the driving unit is provided for each of the coupling portions. In such a configuration, a bend amount of the displacement portion in each of the coupling portions can be controlled by the driving unit provided for each of the coupling portions. In this way, an inclination of the second substrate can be suppressed, and light having a desired target wavelength can be emitted from the variable wavelength interference filter with high accuracy.

What is claimed is:

1. A variable wavelength interference filter comprising:
a first substrate;
a second substrate facing the first substrate via a predetermined gap;
a first reflection film installed at the first substrate;
a second reflection film installed at the second substrate, and facing the first reflection film via a predetermined first gap;
a coupling portion disposed between the first substrate and the second substrate, and including a first facing surface facing the first substrate and a second facing surface facing the second substrate; and
a driving unit configured to change the first gap, wherein
a part of the first facing surface of the coupling portion is coupled to the first substrate,
when viewed from a thickness direction from the first substrate toward the second substrate, a portion of the first facing surface of the coupling portion not coupled to the first substrate constitutes a displacement portion facing the first substrate via a predetermined second gap,
a part of the second facing surface of the displacement portion is coupled to the second substrate, and
the driving unit changes the second gap by bending the displacement portion, thereby changing the first gap.

2. The variable wavelength interference filter according to claim 1, wherein
the driving unit includes a first driving electrode installed at the first substrate, and a second driving electrode installed at the displacement portion and facing the first driving electrode via the second gap.

3. The variable wavelength interference filter according to claim 2, wherein
the coupling portion is formed of silicon, and the coupling portion also functions as the second driving electrode.

4. The variable wavelength interference filter according to claim 1, wherein
the driving unit includes a coil provided at any one of a surface of the first substrate facing the displacement portion and the first facing surface, and a magnetic body provided at the other of the surface of the first substrate facing the displacement portion and the first facing surface.

5. The variable wavelength interference filter according to claim 1, wherein
the driving unit includes a first electrode installed at the first facing surface, a piezoelectric film installed at the first electrode, and a second electrode installed at the piezoelectric film, and the first electrode, the piezoelectric film, and the second electrode are stacked along the thickness direction.

6. The variable wavelength interference filter according to claim 1, wherein
the coupling portion includes a thin plate portion including the first facing surface and the second facing surface, and a column portion protruding from the second facing surface of the thin plate portion toward the second substrate and having a protruding tip portion coupled to the second substrate.

7. The variable wavelength interference filter according to claim 6, wherein
a dimension of the column portion in the thickness direction is smaller than an initial dimension of the first gap in a state where the displacement portion is not deformed by the driving unit.

8. The variable wavelength interference filter according to claim 1, further comprising
a first capacitance detection electrode installed at the first substrate, and a second capacitance detection electrode provided at the first facing surface and facing the first capacitance detection electrode.

9. The variable wavelength interference filter according to claim 1, further comprising
a third capacitance detection electrode provided at the first substrate, and a fourth capacitance detection electrode provided at the second substrate and facing the third capacitance detection electrode, wherein
the third capacitance detection electrode is installed in a position surrounding the first reflection film when viewed from the thickness direction, and
the fourth capacitance detection electrode is installed in a position surrounding the second reflection film when viewed from the thickness direction.

10. The variable wavelength interference filter according to claim 1, wherein,
provided that a region where the first reflection film and the second reflection film overlap each other when viewed from the thickness direction is an optical region, the coupling portion is formed in an annular shape surrounding the optical region, and
the driving unit is formed in an annular shape surrounding the optical region in a position overlapping the coupling portion.

11. The variable wavelength interference filter according to claim 1, wherein,
provided that a region where the first reflection film and the second reflection film overlap each other when viewed from the thickness direction is an optical region, a plurality of the coupling portions are provided in positions that are rotationally symmetrical with respect to the center of the optical region, and a plurality of the driving units are provided correspondingly to the plurality of coupling portions.
